(19) United States
(12) Patent Application Publication
(10) Pub. No.: US 2009/0129466 A1
(43) Pub. Date: May 21, 2009

(54) Method, medium, and apparatus efficiently encoding and decoding moving image using image resolution adjustment

(75) Inventors: Dae-sung Cho, Seoul (KR); Hyun-mun Kim, Seongnam-si (KR); Dae-hee Kim, Suwon-si (KR); Jae-woo Jung, Seoul (KR); Woong-il Choi, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/155,543

(22) Filed: Jun. 5, 2008

(30) Foreign Application Priority Data
Nov. 19, 2007 (KR) 10-2007-0118159

(51) Int. Cl. H04N 7/26

(52) U.S. Cl. 375/240.03; 375/240.01; 375/E07.14

(57) ABSTRACT

A method, medium, and apparatus encoding and/or decoding a moving image. The method of decoding a moving image includes increasing a resolution of a compression image corresponding to a reference image of a current image from among compression images stored in a memory in order to reconstruct the reference image, generating a reconstruction image of the current image by decoding a bitstream by using the reconstructed reference image, and reducing a resolution of the generated reconstruction image in order to compress the reconstruction image and storing the compressed reconstruction image in the memory.

### CROSS-REFERENCE TO RELATED APPLICATIONS

This application claims the benefit of Korean Patent Application No. 10-2007-0118159, filed on Nov. 19, 2007, in the Korean Intellectual Property Office, the disclosure of which is incorporated herein in its entirety by reference.

### BACKGROUND

1. Field

One or more embodiments of the present invention relate to a method, medium, and apparatus encoding and/or decoding a moving image.

2. Description of the Related Art

Once a moving image encoder encodes and outputs each of the images making up a moving image in a compressed form, a moving image decoder can then receive and decode the encoded images, thereby reconstructing an image that approximates the original image. Such compression schemes include lossless compression schemes in which a reconstructed image is the same as an original image and lossy compression schemes in which the reconstructed image is different from the original image.

Representative examples of the lossless compression scheme include an inter mode in which a temporal correlation between images is used and an intra mode in which a spatial correlation between pixels of an image is used. Representative examples of the lossy compression scheme include a transformation process, a quantization process, and an entropy-encoding process.

Moving image compression in the inter mode has required an external memory capable of storing an image reconstructed by the moving image encoder, during the encoding, or the moving image decoder, during the decoding, due to the use of temporal correlation between images of a moving image. In addition, generally, the number of cycles required for a moving image encoder or a moving image decoder to perform a corresponding read or write operation on such an external memory is greater than that required for the moving image encoder or the moving image decoder to execute internal arithmetic operations.

### SUMMARY

One or more embodiments of the present invention provide a method, medium, and apparatus encoding and/or decoding a moving image whereby the number of cycles required to read or write a reference image from or to an external memory can be reduced.

Additional aspects and/or advantages will be set forth in part in the description which follows and, in part, will be apparent from the description, or may be learned by practice of the invention.

To achieve the above and/or other aspects and advantages, embodiments of the present invention include a method of encoding a moving image, the method including reconstructing a reference image of a current image by increasing a resolution of a compression image corresponding to the reference image from a plurality of compression images stored in a memory, encoding the current image by using the reconstructed reference image, generating a reconstruction image of the current image by decoding the encoded current image, and reducing a resolution of the generated reconstruction image to compress the reconstruction image and adding the compressed reconstruction image to the plurality of compression images in the memory.

To achieve the above and/or other aspects and advantages, embodiments of the present invention include an encoding apparatus, the apparatus including a reconstruction unit to reconstruct a reference image of a current image by increasing a resolution of a compression image corresponding to the reference image from a plurality of compression images stored in a memory, an encoding unit to implement prediction encoding of the current image by using the reconstructed reference image, a decoding unit to generate a reconstruction image of the current image by decoding the encoded current image, and a compression unit to reduce a resolution of the generated reconstruction image to compress the reconstruction image and to add the compressed reconstruction image to the plurality of compression images in the memory.

To achieve the above and/or other aspects and advantages, embodiments of the present invention include a method of decoding a moving image, the method including reconstructing a reference image of a current image by increasing a resolution of a compression image corresponding to the reference image from among a plurality of compression images stored in a memory, generating a reconstruction image of the current image by decoding a bitstream and applying the reconstructed reference image to the decoded bitstream, and reducing a resolution of the generated reconstruction image to compress the reconstruction image and adding the compressed reconstruction image to the plurality of compression images in the memory.

To achieve the above and/or other aspects and advantages, embodiments of the present invention include a decoding apparatus, the apparatus including a reconstruction unit to reconstruct a reference image of a current image by increasing a resolution of a compression image corresponding to the reference image from among a plurality of compression images stored in a memory, a decoding unit to implement prediction decoding to generate a reconstruction image of the current image by decoding a bitstream and applying the reconstructed reference image to the decoded bitstream, and a compression unit to reduce a resolution of the generated reconstruction image to compress the reconstruction image and to add the compressed reconstruction image to the plurality of compression images in the memory.

To achieve the above and/or other aspects and advantages, embodiments of the present invention include a method of decoding a moving image, the method including reconstructing a reference image of a current image by increasing a resolution of a compression image corresponding to the reference image from among a plurality of compression images stored in a memory, generating a prediction image of the current image from the reconstructed reference image, reconstructing a residue image between the generated prediction image and the current image through a decoding of a bitstream, reducing a resolution of the reconstructed residue image, generating a reconstruction image of the current image by adding the reduced resolution residue image to the generated prediction image, and reducing a resolution of the generated reconstruction image to compress the reconstruction image and adding the compressed reconstruction image to the plurality of compression images in the memory.

To achieve the above and/or other aspects and advantages, embodiments of the present invention include a method of decoding a moving image, the method including reconstructing a reference image of a current image by increasing a resolution of a compression image corresponding to the reference image from among a plurality of compression images stored in a memory, generating a prediction image of the current image from the reconstructed reference image, reconstructing a residue image between the generated prediction image and the current image through a decoding of a bitstream, generating a reconstruction image of the current image by adding the reconstructed residue image to the generated prediction image, and reducing a resolution of the generated reconstruction image to compress the reconstruction image and adding the compressed reconstruction image to the plurality of compression images in the memory.

To achieve the above and/or other aspects and advantages, embodiments of the present invention include a method of compressing an image, the method including selecting an offset value of a predetermined-size block of an image, from among a plurality of offset values, based on values of pixels making up the block, selecting a quantization size of the block, from among a plurality of quantization sizes, based on the values of the pixels of the block, and performing a quantization operation by dividing differences between respective values of the pixels and the selected offset value by the selected quantization size.

To achieve the above and/or other aspects and advantages, embodiments of the present invention include a method of reconstructing an image, the method including extracting an offset value of a predetermined-size block of an image and a quantization size of the block from the block, and performing an inverse quantization operation by multiplying a quantization value of each of plural pixels making up the block by the extracted quantization size and summing a result of the multiplication and the extracted offset value to reconstruct original bits of each of the plural pixels.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an apparatus for encoding a moving image, according to an embodiment of the present invention;

FIG. 2 is a block diagram of an apparatus for decoding a moving image, according to an embodiment of the present invention;

FIG. 3 is a block diagram of an apparatus for encoding a moving image, according to an embodiment of the present invention;

FIG. 4 is a block diagram of an apparatus for decoding a moving image, according to an embodiment of the present invention;

FIG. 5 illustrates an example of a reference image used by a motion compensation unit, such at the motion compensation units illustrated in FIGS. 1 through 4, according to embodiments of the present invention;

FIG. 6A illustrates a structure of bit resolution adjustment information, according to an embodiment of the present invention;

FIG. 6B illustrates the structure of the bit resolution adjustment information illustrated in FIG. 6A, in the form of a pseudo code, according to an embodiment of the present invention;

FIG. 6C illustrates two examples of the structures of the bit resolution adjustment information illustrated in FIGS. 6A and 6B, according to embodiments of the present invention;

FIG. 7 is a histogram of a luminance component and a chrominance component of a general image;

FIG. 8 is a diagram for explaining a definition of offset values for a luminance component illustrated in example (1) of FIG. 6C, according to an embodiment of the present invention;

FIG. 9 is a diagram for explaining a definition of offset values for a chrominance component illustrated in example (1) of FIG. 6C, according to an embodiment of the present invention;

FIG. 10 is a histogram of a difference between a maximum value and a minimum value of each of a luminance component and a chrominance component of a 2×2 block in a general image;

FIG. 11A illustrates a structure of a reference image of a luminance component compressed according to an embodiment of the present invention;

FIG. 11B illustrates the structure of the reference image of the luminance component illustrated in FIG. 11A, in the form of a pseudo code, according to an embodiment of the present invention;

FIG. 12A illustrates a structure of a reference image of a chrominance component compressed according to an embodiment of the present invention;

FIG. 12B illustrates the structure of the reference image of the chrominance component illustrated in FIG. 12A, in the form of a pseudo code, according to an embodiment of the present invention;

FIG. 13 is a block diagram of an apparatus compressing an image, according to an embodiment of the present invention;

FIG. 14 is a block diagram of an apparatus reconstructing an image, according to an embodiment of the present invention;

FIG. 15 illustrates an example of a relationship between a value that is input to a quantization unit illustrated in FIG. 13 and a value that is reconstructed by an inverse quantization unit illustrated in FIG. 14, according to an embodiment of the present invention;

FIG. 16 illustrates an example of a quantization error between the value that is input to the quantization unit illustrated in FIG. 13 and the value that is reconstructed by the inverse quantization unit illustrated in FIG. 14, according to an embodiment of the present invention;

FIG. 17 illustrates another example of the quantization error between the value input to the quantization unit illustrated in FIG. 13 and the value reconstructed by the inverse quantization unit illustrated in FIG. 14, according to an embodiment of the present invention;

FIG. 18 is a flowchart illustrating a method of encoding a moving image, according to an embodiment of the present invention;

FIG. 19 is a flowchart illustrating a method of decoding a moving image, according to an embodiment of the present invention;

FIG. 20 is a flowchart illustrating a method of encoding a moving image, according to another embodiment of the present invention;

FIG. 21 is a flowchart illustrating a method of decoding a moving image, according to another embodiment of the present invention;

FIG. 22 is a flowchart illustrating a method of compressing an image, according to an embodiment of the present invention; and

FIG. 23 is a flowchart illustrating a method of reconstructing an image, according to an embodiment of the present invention.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are merely described below, by referring to the figures, to explain aspects of the present invention.

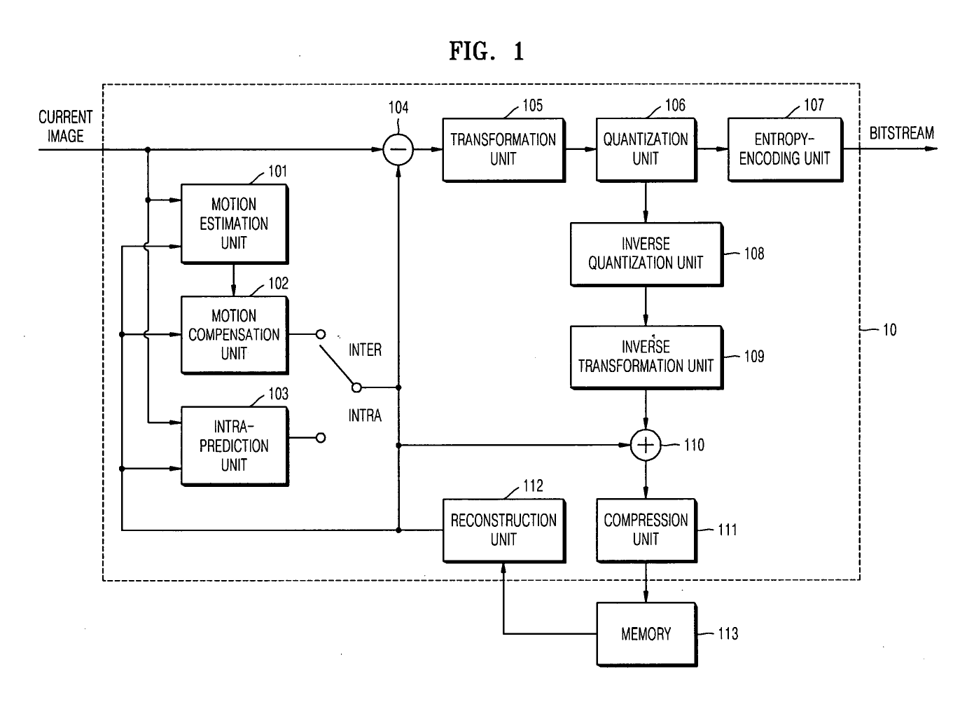

FIG. 1 is a block diagram of an apparatus 10 encoding a moving image, according to an embodiment of the present invention. Herein, the term apparatus should be considered synonymous with the term system, and not limited to a single enclosure or all described elements embodied in single respective enclosures in all embodiments, but rather, depending on embodiment, is open to being embodied together or separately in differing enclosures and/or locations through differing units or elements, e.g., a respective apparatus/system could be a single processing element or implemented through a distributed network, noting that additional and alternative embodiments are equally available.

Referring to FIG. 1, the apparatus 10 may include a motion estimation unit 101, a motion compensation unit 102, an intra-prediction unit 103, a subtraction unit 104, a transformation unit 105, a quantization unit 106, an entropy-encoding unit 107, an inverse quantization unit 108, an inverse transformation unit 109, an addition unit 110, a compression unit 111, and a reconstruction unit 112, for example.

The motion estimation unit 101 may estimate a motion of a current image that is currently input from an external device from among images that make up a moving image based on at least one of reference images reconstructed by the reconstruction unit 112. More specifically, for each of the blocks corresponding to an inter mode from among all blocks of the current image, the motion estimation unit 101 determines a block of a reference image, which best matches a block of the current image, from among the reference images reconstructed by the reconstruction unit 112 and calculates a motion vector indicating displacement between the determined block of the reference image and the block of the current image.

The motion compensation unit 102 generates a prediction image of the current image from at least one of the reference images reconstructed by the reconstruction unit 112 by using motion vectors obtained by the motion estimation unit 101. More specifically, the motion compensation unit 102 determines values of blocks of at least one reference image, which are indicated by the calculated motion vectors of the blocks of the current image, as values of the blocks of the current image, thereby generating the prediction image of the current image.

For each of the blocks corresponding to the intra mode from among all the blocks of the current image, the intra-prediction unit 103 predicts a value of the block of the current image from a value of a block of a reconstruction image, which is located adjacent to the block of the current image from among all blocks of the reconstruction image generated by the reconstruction unit 112, thereby generating a prediction image of the current image. The subtraction unit 104 subtracts the prediction image generated by the motion compensation unit 102 or the intra-prediction unit 103 from the current image, thereby generating a residue image between the current image and the prediction image.

The transformation unit 105 transforms the residue image generated by the subtraction unit 104 from a color domain into a frequency domain. For example, the transformation unit 105 may transform the residue image generated by the subtraction unit 104 from the color domain into the frequency domain by using discrete Hadamard transformation (DHT) or discrete cosine transformation (DCT), noting that alternative are also available. The quantization unit 106 quantizes transformation results obtained by the transformation unit 105. More specifically, the quantization unit 106 may divide the transformation results obtained by the transformation unit 105, i.e., frequency component values, according to a quantization size and approximate quantization results to integers.

The entropy-encoding unit 107 performs entropy-encoding on the quantization results obtained by the quantization unit 106, thereby generating a bitstream. For example, the entropy-encoding unit 107 may perform entropy-encoding on the quantization results obtained by the quantization unit 106 by using context-adaptive variable-length coding (CAVLC) or context-adaptive binary arithmetic coding (CABAC), noting that alternatives are also available. In particular, the entropy-encoding unit 107 may entropy-encode information required for moving image decoding, e.g., index information of a reference image used for inter-prediction, motion vector information, and position information of a block of a reconstruction image used for intra-prediction, in addition to the quantization results obtained by the quantization unit 106. According to this embodiment, the entropy-encoding unit 107 may also entropy-encode bit resolution adjustment information that is to be described below.

The inverse quantization unit 108 performs inverse quantization on the quantization results obtained by the quantization unit 106. More specifically, the inverse quantization unit 108 may reconstruct frequency component values by multiplying the integers approximated by the quantization unit 106 by the quantization size, for example. The inverse transformation unit 109 may then transform the inverse-quantization results obtained by the inverse quantization unit 108, i.e., the frequency component values, from the frequency domain into the color domain, thereby reconstructing a residue image between the current image and the prediction image. The addition unit 110 adds the residue image reconstructed by the inverse transformation unit 109 to the prediction image generated by the motion compensation unit 102 or the intra-prediction unit 103, thereby generating a reconstruction image of the current image.

The compression unit 111 may then compress the reconstruction image generated by the addition unit 110 by reducing the resolution of the reconstruction image, and further store the compressed reconstruction image, i.e., a compression image, in a memory 113. More specifically, in an embodiment, the compression unit 111 determines a reduction for a bit resolution of each of pixels making up the reconstruction image generated by the addition unit 110 in units of 2×2 blocks by referring to bit resolution adjustment information, and reduces the bit resolution of each of the pixels by the determined reduction, thereby compressing the reconstruction image.

Herein, the term “bit resolution” means the number of bits that express a value of each pixel. Throughout embodiments of the present invention, it can be easily understood by those of ordinary skill in the art that a bit resolution can be replaced with other terms such as a bit depth or a color depth, for example. In other words, the compression unit 111 compresses the reconstruction image generated by the addition unit 110 by reducing the number of bits expressing a value of each of the pixels making up the reconstruction image by the determined reduction.

In general, a basic unit of access to the memory 113, i.e., the smallest unit of a read or write operation from or to the memory 113, is 8 bits, i.e., 1 byte. Thus, in an embodiment, the compression unit 111 reduces the bit resolution of each of the pixels of the reconstruction image in units of 2×2 blocks. Here, the total amount of data of a 2×2 block for a color value, e.g., one of a Y color value, a Cb color value, and a Cr color value, is 4 bytes because the amount of data of a color value of each of 4 pixels making up the 2×2 block is 8 bits. In particular, although a value of each of pixels making up an image is composed of a Y color value, a Cb color value, and a Cr color value in the current embodiment, it can be easily understood by those of ordinary skill in the art that other types of color space, such as a R color value, a G color value, and a B color value, can also be used throughout embodiments of the present invention, noting that further alternatives are equally available.

Thus, considering the basic unit of access to the memory 113, the amount of data of a 2×2 block for a color value can be reduced to 1 to 3 bytes. However, the amount of information that can express an image is very small in the case of a 2×2 block of 1 byte, and so, only cases where the amount of data of a 2×2 block for a color value is reduced to 2 or 3 bytes will be considered in the current embodiment. For example, if a value of each of pixels making up the reconstruction image generated by the addition unit 110 is composed of a Y color value of 8 bits, a Cb color value of 8 bits, and a Cr color value of 8 bits, the compression unit 111 may reduce the number of bits expressing each of the Y color value, the Cb color value, and the Cr color value of each pixel of the reconstruction image, i.e., 8 bits, by 4 or 2 bits. Thus, the Y color value of 8 bits, the Cb color value of 8 bits, and the Cr color value of 8 bits may be expressed as a Y color value of 4 or 6 bits, a Cb color value of 4 or 6 bits, and a Cr color value of 4 or 6 bits.

Here, although a bit resolution of each of the pixels making up an image is adjusted in 2×2 block units in the current embodiment, it can be easily understood by those of ordinary skill in the art that a bit resolution of each of pixels making up an image can also be adjusted in various block units such as 4×4 block units, 8×8 block units, and 16×16 block units, for example.

Accordingly, the reconstruction unit 112 generates a reconstruction image of an current image by increasing the resolution of a compression image stored in the memory 113. More specifically, the reconstruction unit 112 may determine the needed increase for the bit resolution of each of pixels making up the compression image stored in the memory 113 in units of 2×2 blocks by referring to bit resolution adjustment information, for example, and increase the bit resolution of each pixel by the determined increase, thereby generating a final reconstruction image of the current image. In other words, the reconstruction unit 112 may generate the final reconstruction image of the current image by increasing the number of bits expressing the value of each pixel of the compression image stored in the memory 113 by the determined increase.

Here, in this embodiment, since a resolution of the final reconstruction image generated by the reconstruction unit 112 is the same as that of an original image, the reduction used by the compression unit 111 should be the same as the increase used by the reconstruction unit 112. For example, if a value of each of the pixels making up the compression image stored in the memory 113 is composed of a Y color value of 4 or 6 bits, a Cb color value of 4 or 6 bits, and a Cr color value of 4 or 6 bits, the reconstruction unit 112 may increase the number of bits expressing each of the Y color value, the Cb color value, and the Cr color value of each of the pixels making up the compression image, i.e., 8 bits, by 4 or 2 bits. Thus, the Y color value of 4 or 6 bits, the Cb color value of 4 or 6 bits, and the Cr color value of 4 or 6 bits may be expressed as a Y color value of 8 bits, a Cb color value of 8 bits, and a Cr color value of 8 bits.

The final reconstruction image generated by the reconstruction unit 112 can then be used as a reference image for future images following a current input image or past images preceding the current input image. In other words, the reconstruction unit 112 can reconstruct a reference image used for images other than the current input image by increasing the resolution of the compression image stored in the memory 113.

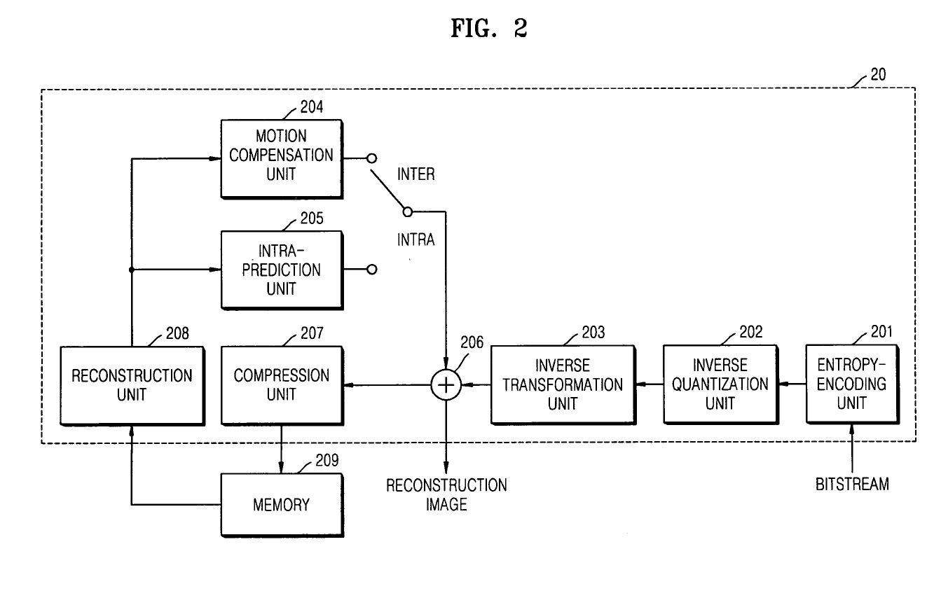

FIG. 2 is a block diagram of an apparatus 20 decoding a moving image, according to an embodiment of the present invention. Referring to FIG. 2, the apparatus 20 may include an entropy-decoding unit 201, an inverse quantization unit 202, an inverse transformation unit 203, a motion compensation unit 204, an intra-prediction unit 205, an addition unit 206, a compression unit 207, and a reconstruction unit 208, for example. An image reconstruction process performed by the apparatus 20 may be similar to that performed by the apparatus 10 illustrated in FIG. 1, for example. Thus, although not provided below, portions of the above description regarding the apparatus 10 illustrated in FIG. 1 may also be applied to the description below regarding the apparatus 20, according to such an embodiment of the present invention.

The entropy-decoding unit 201 entropy-decodes a bitstream, e.g., as generated and output from the apparatus 10 illustrated in FIG. 1, thereby reconstructing integers corresponding to a moving image and information required to decode the moving image. The inverse quantization unit 202 inversely quantizes the integers reconstructed by the entropy-decoding unit 201, thereby reconstructing frequency component values. The inverse transformation unit 203 may then transform the frequency component values reconstructed by the inverse quantization unit 202 from a frequency domain into a color domain, for example, thereby reconstructing a residue image between a current image and a prediction image.

The motion compensation unit 204 may then perform motion compensation on the current image based on at least one of the reference images generated by the reconstruction unit 208, thereby generating a prediction image of the current image from the at least one reference image. For each of the blocks corresponding to an intra mode from among all blocks making up the current image, the intra-prediction unit 205 may predict a value of the block of the current image from a value of a block of a reconstruction image, e.g., located adjacent to the block of the current image, from among all blocks of a reconstruction image generated by the reconstruction unit 208, thereby generating a prediction image of the current image. The addition unit 206 may add the residue image reconstructed by the inverse transformation unit 203 to the prediction image generated by the motion compensation unit 204 or the intra-prediction unit 205, thereby generating a reconstruction image of the current image.

Similar to above, the compression unit 207 may further compress the reconstruction image generated by the addition unit 206 by reducing the resolution of the reconstruction image and store the compressed reconstruction image, i.e., a compression image, in a memory 209. More specifically, in an embodiment, the compression unit 207 may determine the desired reduction for the bit resolution of each of pixels making up the reconstruction image generated by the addition unit 206 in units of 2×2 blocks, for example, by referring to bit resolution adjustment information, and reduce the bit resolution of each of the pixels by the determined reduction, thereby compressing the reconstruction image.

The reconstruction unit 208 may, thus, increase the resolution of the compression image stored in the memory 209, thereby generating a final reconstruction image. More specifically, in this example, the reconstruction unit 208 generates the final reconstruction image by determining an increase for the bit resolution of each of the pixels making up the compression image stored in the memory 209 in units of 2×2 blocks by referring to the bit resolution adjustment information and increasing the bit resolution of each of the pixels by the determined increase. In other words, in an embodiment, the reconstruction unit 208, thus, generates a reference image used for images other than the image used to generate the corresponding compressed image by increasing a resolution of the compression image stored in the memory 209.

According to such an embodiment, the needed amount of data of for reference image stored in an external memory can be reduced by compressing the reference image by reducing the resolution of the reference image and storing the compressed reference image in the external memory. Thus, the number of cycles required for a moving image encoder or a moving image decoder to read or write a reference image from or to the external memory can be reduced. In addition, such a reduction in the number of cycles leads to a reduction in the number of cycles taken for the entire moving image encoding/decoding process, thereby providing a moving image encoder or a moving image decoder having low power consumption.

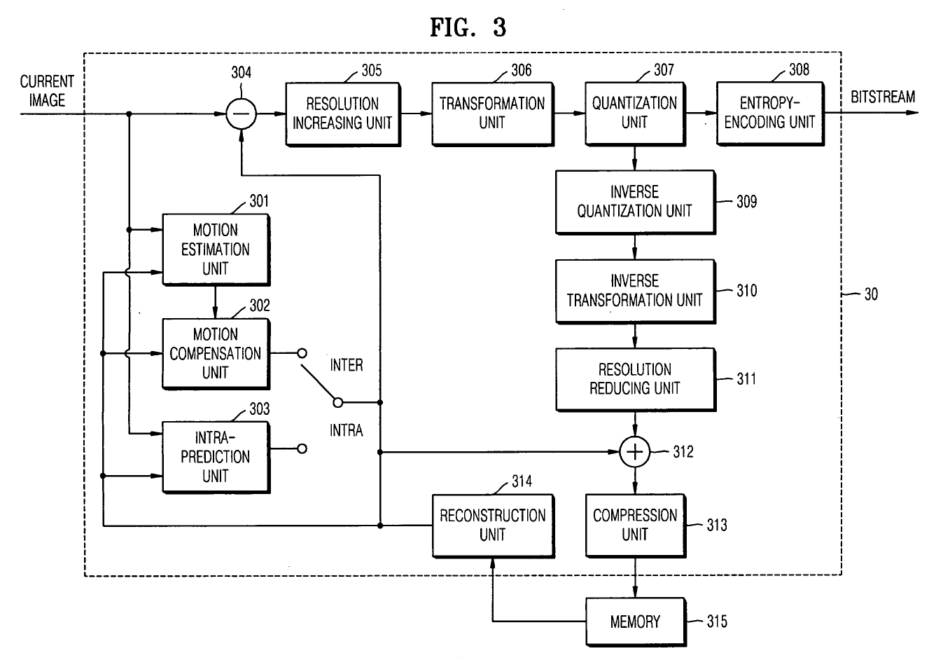

FIG. 3 is a block diagram of an apparatus 30 encoding a moving image, according to an embodiment of the present invention. Referring to FIG. 3, the apparatus 30 may include a motion estimation unit 301, a motion compensation unit 302, an intra-prediction unit 303, a subtraction unit 304, a resolution increasing unit 305, a transformation unit 306, a quantization unit 307, an entropy-encoding unit 308, an inverse quantization unit 309, an inverse transformation unit 310, a resolution reducing unit 311, an addition unit 312, a compression unit 313, and a reconstruction unit 314, for example. The apparatus 30 may be similar to the apparatus 10 illustrated in FIG. 1 except that the resolution increasing unit 305 and the resolution reducing unit 311 have been further illustrated. Thus, although not provided below, above descriptions regarding the apparatus 10 may also be applied to the below description regarding the apparatus 30, according to an embodiment of the present invention.

Accordingly, the motion estimation unit 301 may estimate a motion of a current image from among images that make up a moving image based on at least one of the reference images reconstructed by the reconstruction unit 314. More specifically, the motion compensation unit 302 may generate a prediction image of the current image from at least one of the reference images reconstructed by the reconstruction unit 314 by using motion vectors obtained by the motion estimation unit 301. In an embodiment, for each of blocks corresponding to an intra mode, from among all blocks of the current image, the intra-prediction unit 303 may predict a value of the block of the current image from a value of a block of a reconstruction image, which is located adjacent to the block of the current image, from among all blocks of the reconstruction image generated by the reconstruction unit 314, thereby generating a prediction image of the current image. The subtraction unit 304 may then subtract the prediction image generated by the motion compensation unit 304 or the intra-prediction unit 303 from the current image, thereby generating a residue image between the current image and the prediction image.

The resolution increasing unit 305 may then increase the resolution of the residue image generated by the subtraction unit 305. More specifically, the resolution increasing unit 305 may determine the desired increase for the bit resolution of each of pixels making up the residue image generated by the subtraction unit 305, e.g., by referring to bit resolution adjustment information, and increase the bit resolution of each of the pixels by the determined increase. In other words, in an embodiment, the resolution increasing unit 305 may increase the number of bits expressing the value of each of the pixels making up the residue image generated by the subtraction unit 305 by the determined increase. For example, if a value of each of the pixels making up the residue image generated by the subtraction unit 305 is composed of a Y color value of 9 bits, a Cb color value of 9 bits, and a Cr color value of 9 bits, the resolution increasing unit 305 may increase the number of bits expressing each of the Y color value, the Cb color value, and the Cr color value of each of the pixels, i.e., 9 bits, by 1 or 3 bits. Thus, the Y color value of 9 bits, the Cb color value of 9 bits, and the Cr color value of 9 bits may be expressed as a Y color value of 10 or 12 bits, a Cb color value of 10 or 12 bits, and a Cr color value of 10 or 12 bits. Thus, the precision of operations performed during a lossy compression, e.g., a transformation operation, a quantization operation, and an entropy-encoding operation, can be improved, thereby alleviating degradation of the quality of a final reconstruction image due to resolution reduction caused by the compression unit 313.

The transformation unit 306 then transforms the residue image whose resolution has been increased by the resolution increasing unit 305 from the color domain into the frequency domain, the quantization unit 307 quantizes transformation results obtained by the transformation unit 306, and the entropy-encoding unit 308 entropy-encodes quantization results obtained by the quantization unit 307, thereby generating a bitstream. The inverse quantization unit 309 may inversely quantize the quantization results obtained by the quantization unit 307, and the inverse transformation unit 310 may then transform inverse-quantization results obtained by the inverse quantization unit 309, i.e., frequency component values, from the frequency domain into the color domain, thereby reconstructing a residue image between the current image and the prediction image.

The resolution reducing unit 311 may further reduce the resolution of the residue image reconstructed by the inverse transformation unit 310. More specifically, in an embodiment, the resolution reducing unit 311 may determine the desired reduction for a bit resolution of each of the pixels making up the residue image reconstructed by the inverse transformation unit 310, e.g., by referring to bit resolution adjustment information, and reduce the bit resolution of each of the pixels by the determined reduction. In other words, the resolution reducing unit 311 reduces the number of bits expressing a value of each of the pixels making up the residue image reconstructed by the inverse transformation unit 309 by the determined reduction.

In an embodiment, since the resolution of the residue image reduced by the resolution reducing unit 311 is the same as that of an original image, the increase used by the resolution increasing unit 305 should be the same as the reduction used by the resolution reducing unit 311. For example, if a value of each of the pixels making up the residue image whose resolution has been increased by the resolution increasing unit 305 is composed of a Y color value of 10 bits, a Cb color value of 10 bits, and a Cr color value of 10 bits, the resolution reducing unit 311 reduces the number of bits expressing the Y color value, the Cb color value, and the Cr color value of each of the pixels, i.e., 10 bits, by 1 bit. Thus, the Y color value of 10 bits, the Cb color value of 10 bits, and the Cr color value of 10 bits can be expressed as a Y color value of 9 bits, a Cb color value of 9 bits, and a Cr color value of 9 bits.

The addition unit 312 adds the residue image whose resolution has been reduced by the resolution reducing unit 311 to the prediction image, generated by the motion compensation unit 302 or the intra-prediction unit 303, thereby generating a reconstruction image of the current image. In an embodiment, the compression unit 313 may then compress the reconstruction image by reducing the resolution of the reconstruction image generated by the addition unit 312 and store the compressed reconstruction image, i.e., a compression image, in the memory 315. The reconstruction unit 314 may thereafter generate a final reconstruction image by increasing a resolution of the compression image stored in the memory 315.

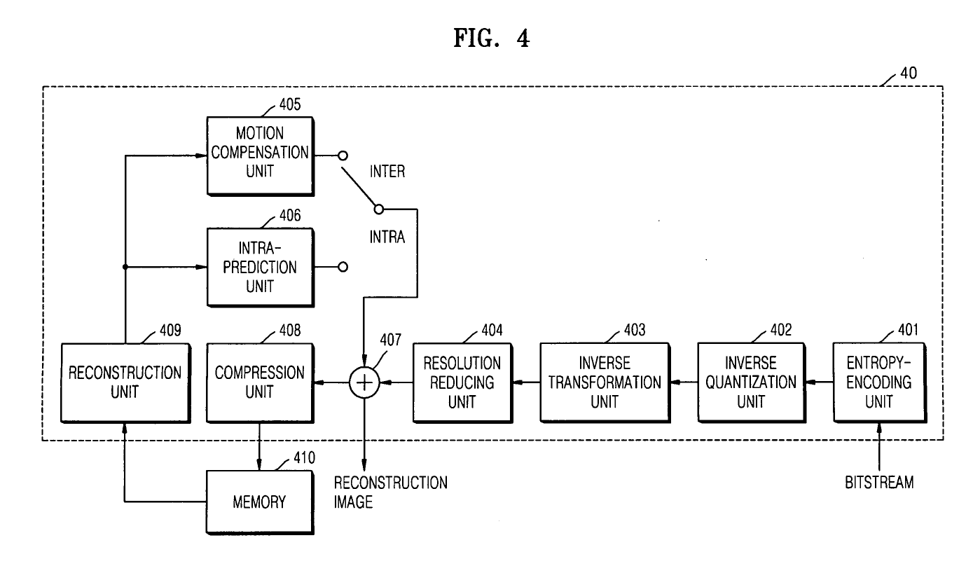

FIG. 4 is a block diagram of an apparatus 40 for decoding a moving image, according to an embodiment of the present invention. Referring to FIG. 4, the apparatus 40 may include an entropy-decoding unit 401, an inverse quantization unit 402, an inverse transformation unit 403, a resolution reducing unit 404, a motion compensation unit 405, an intra-prediction unit 406, an addition unit 407, a compression unit 408, and a reconstruction unit 409, for example. An image reconstruction process performed by the apparatus 40 may be similar to that performed by the apparatus 20 illustrated in FIG. 2, except apparatus 40 further illustrates the resolution reducing unit 404. Thus, although not provided below, above descriptions regarding the apparatus 20 may also be applied to the below description regarding the apparatus 40, according an embodiment of the present invention.

The entropy-decoding unit 401 may entropy-decode a bitstream, e.g., as generated and output from the apparatus 30 illustrated in FIG. 3, thereby reconstructing integers corresponding to a moving image and information required to decode the moving image. The inverse quantization unit 402 inversely quantizes the integers reconstructed by the entropy-decoding unit 401, thereby reconstructing frequency component values. The inverse transformation unit 403 transforms the frequency component values reconstructed by the inverse quantization unit 402 from a frequency domain into a color domain, thereby reconstructing a residue image between a current image and a prediction image.

The resolution reducing unit 404 may further reduce a resolution of the residue image reconstructed by the inverse transformation unit 403. More specifically, the resolution reducing unit 404 may determine the desired reduction for a bit resolution of each of pixel making up the residue image reconstructed by the inverse transformation unit 403, e.g., by referring to bit resolution adjustment information, and reduce the bit resolution of each of the pixels by the determined reduction. In other words, the resolution reduction unit 404 may reduce the number of bits expressing a value of each of the pixels making up the residue image reconstructed by the inverse transformation unit 309 by the determined reduction.

In an embodiment, since the resolution of the residue image reduced by the resolution reducing unit 404 is the same as that of an original image, the increase used by the resolution increasing unit 305 illustrated in FIG. 3 should be the same as the reduction used by the reduction reducing unit 404. For example, if a value of each of the pixels making up the residue image whose resolution has been increased by the resolution increasing unit 305 is composed of a Y color value of 10 bits, a Cb color value of 10 bits, and a Cr color value of 10 bits, the resolution reducing unit 404 reduces the number of bits expressing each of the Y color value, the Cb color value, and the Cr color value of each pixel of the residue image, i.e., 10 bits by 1 bit. Thus, the Y color value of 10 bits, the Cb color value of 10 bits, and the Cr color value of 10 bits are expressed as a Y color value of 9 bits, a Cb color value of 9 bits, and a Cr color value of 9 bits.

The motion compensation unit 405 may then perform motion compensation on the current image based on at least one of the reference images generated by the reconstruction unit 409, thereby generating a prediction image of the current image from the at least one reference image. For each of the blocks corresponding to an intra mode from among all blocks making up the current image, the intra-prediction unit 406 may predict a value of the block of the current image from a value of a block of a reconstruction image, which is located adjacent to the block of the current image, from among all blocks of a reconstruction image generated by the reconstruction unit 409, thereby generating a prediction image of the current image. The addition unit 407 may further add the residue image whose resolution has been reduced by the resolution reducing unit 404 to the prediction image generated by the motion compensation unit 405 or the intra-prediction unit 406, thereby generating a reconstruction image of the current image.

The compression unit 408 may further compresses the reconstruction image generated by the addition unit 407 by reducing the resolution of the reconstruction image and store the compressed reconstruction image, i.e., a compression image, in a memory 410. More specifically, the compression unit 408 may determine the needed reduction for a bit resolution of each of the pixels making up the reconstruction image generated by the addition unit 407 in units of 2×2 blocks, e.g., by referring to bit resolution adjustment information, and reduce the bit resolution of each of the pixels by the determined reduction, thereby compressing the reconstruction image.

The reconstruction unit 409 may thereafter increase the resolution of the compression image stored in the memory 410, thereby generating a final reconstruction image. More specifically, in an embodiment, the reconstruction unit 409 generates the final reconstruction image by determining an increase for a bit resolution of each of the pixels making up the compression image stored in the memory 410 in units of 2×2 blocks by referring to the bit resolution adjustment information and increasing the bit resolution of each of the pixels by the determined increase. In other words, in an embodiment, the reconstruction unit 409 may generate a reference image used for images other than the image used to generate the corresponding compressed image by increasing a resolution of the compression image stored in the memory 410.

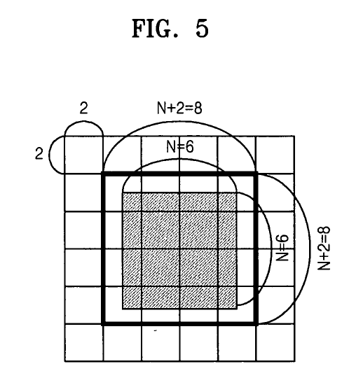

FIG. 5 illustrates an example of a reference image used by a motion compensation unit, such as the motion compensation unit 102 illustrated in FIG. 1, the motion compensation unit 204 illustrated in FIG. 2, the motion compensation unit 302 illustrated in FIG. 3, and the motion compensation unit 405 illustrated in FIG. 4. Referring to FIG. 5, the size of the reference image used by the motion compensation units 102, 204, 302, and 405, for example, may be a 6×6 block, according to an embodiment. However, since each of the example reconstruction unit 112 illustrated in FIG. 1, the reconstruction unit 208 illustrated in FIG. 2, the reconstruction unit 314 illustrated in FIG. 3, and the reconstruction unit 409 illustrated in FIG. 4 generate a reconstruction image in units of 2×2 blocks, each of the reconstruction units 112, 208, 314, and 409, for example, may generate a larger reference image than the 6×6 block desired by each of the motion compensation units 102, 204, 302, and 405 if an edge of a reference image indicated by a motion vector exists within a 2×2 block generated by each of the reconstruction units 112, 208, 314, and 409.

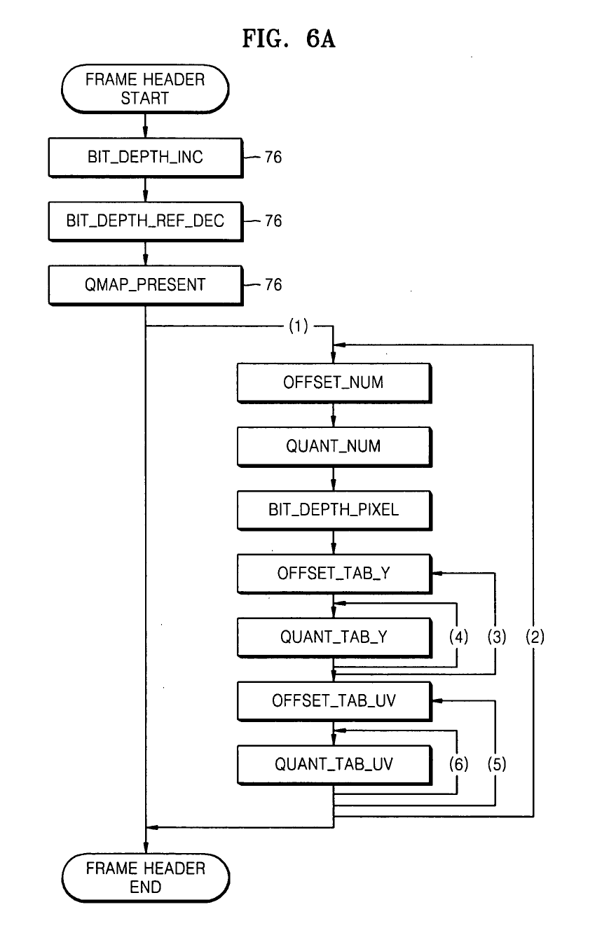

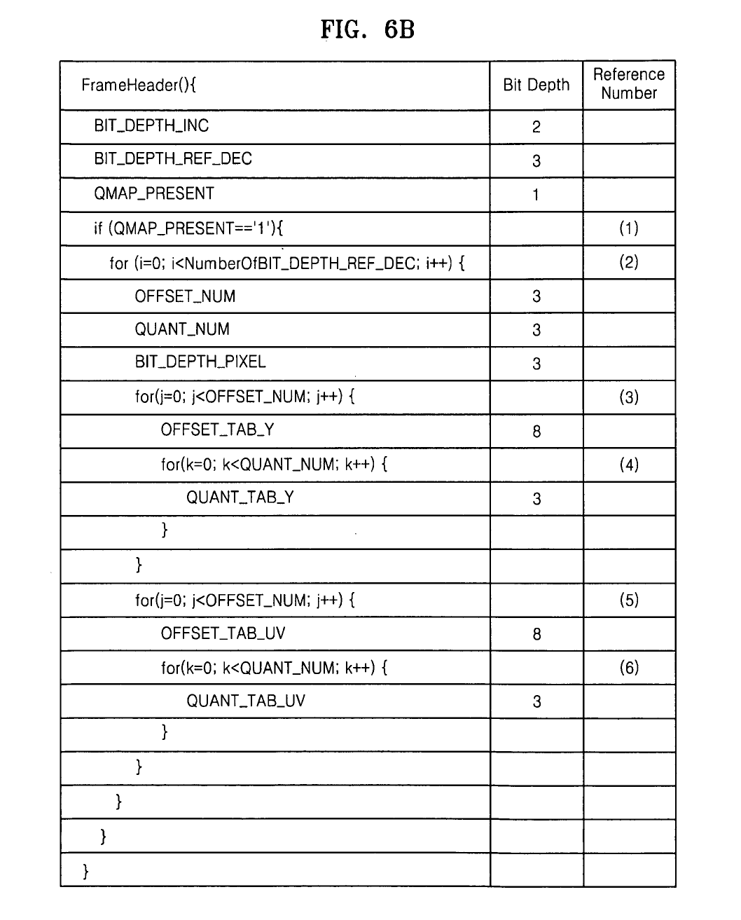

FIG. 6A illustrates a structure of bit resolution adjustment information, according to an embodiment of the present invention. Referring to FIG. 6A, the bit resolution adjustment information, according to an embodiment, may include a BIT_DEPTH_INC field, a BIT_DEPTH_REF_DEC field, a QMAP_PRESENT field, an OFFSET_NUM field, a QUANT_NUM field, a BIT_DEPTH_PIXEL field, an OFFSET_TAB_Y field, a QUANT_TAB_Y field, an OFFSET_TAB_UV field, and a QUANT_TAB_UV field, for example. In particular, the bit resolution adjustment information illustrated in FIG. 6A may be structured in such a manner that different fields are repeated according to a value recorded in a field. To reflect such a structure, the structure of the bit resolution adjustment information is shown in the form of the illustrated flowchart. FIG. 6A takes an example where the bit resolution adjustment information is contained in a frame header in which image encoding information is recorded.

A value indicating an increase for a bit resolution of each of pixels making up a moving image may be recorded in the BIT_DEPTH_INC field. A value indicating a reduction for the bit resolution of each of the pixels may be recorded in the BIT_DEPTH_REF_DEC field. “1” may be recorded in the QMAP_PRESENT field if the bit resolution adjustment information is updated in units of bitstreams or frames, and “0” recorded in the QMAP_PRESENT field if the bit resolution adjustment information is previously fixed. If the bit resolution adjustment information is updated in units of bitstreams or frames, the apparatus 10 illustrated in FIG. 1 or the apparatus 30 illustrated in FIG. 3, both as examples, may update the bit resolution adjustment information based on the characteristics of the moving image or an environment where the moving image is used. For example, if the moving image does not change sharply or the quality of the moving image is not an important factor, the example apparatus 10 or the apparatus 30 may set the reduction for the bit resolution to a large value. Such a setting operation may be manually performed by a user or may be automatically performed based on moving image analysis results.

Since the example apparatus 10 illustrated in FIG. 1 and the apparatus 20 illustrated in FIG. 2, or the apparatus 30 illustrated in FIG. 3 and the apparatus 40 illustrated in FIG. 4 have similar moving image reconstruction environments, they share bit resolution adjustment information. To this end, the apparatus 10 illustrated in FIG. 1 may transmit the bit resolution adjustment information to the apparatus 20 illustrated in FIG. 2 in a frame header of a bitstream, for example. Similarly, the apparatus 30 illustrated in FIG. 3 may transmit the bit resolution adjustment information to the apparatus 40 illustrated in FIG. 4, for example. However, if previously fixed bit resolution adjustment information is used, it may not be necessary to transmit such bit resolution adjustment information by designing a moving image encoder and a moving image decoder so that the bit resolution adjustment information is embedded in the moving image encoder and the moving image decoder.

A value indicating the number of offset values may be recorded in the OFFSET_NUM field. A value indicating the number of quantization sizes for each offset value may be recorded in the QUANT_NUM field. A value indicating an actual bit size of a pixel value whose bit resolution has been adjusted when the pixel value is stored in a memory may further be recorded in the BIT_DEPTH_PIXEL field. Since an offset value and a quantization size which correspond to bit resolution adjustment information used for image compression may have to be stored in a memory, together with a compression image, according to an embodiment, a pixel value stored in the memory is less than the pixel value whose bit resolution has been adjusted.

The number of OFFSET_TAB_Y fields may be the same as the number of offset values recorded in the OFFSET_NUM field. In each of the OFFSET_TAB_Y fields, an offset value for a luminance component may be recorded. The number of QUANT_TAB_Y fields may be same as the number of quantization sizes for each offset value, which is recorded in the QUANT_NUM field. In each of the QUANT_TAB_Y fields, a quantization size for a luminance component may further be recorded. The number of OFFSET_TAB_UV fields may be the same as the number of offset values recorded in the OFFSET_NUM field. In each of the OFFSET_TAB_UV fields, an offset value for a chrominance component may similarly be recorded. The number of QUANT_TAB_UV fields may be the same as the number of quantization sizes for each offset value, which is recorded in the QUANT_NUM field. In each of the QUANT_TAB_UV fields, a quantization size for a chrominance component may also be recorded.

FIG. 6B illustrates a structure of bit resolution adjustment information, such as that illustrated in FIG. 6A, in the form of a pseudo code. Among the items of the table illustrated in FIG. 6B, a “bit depth” indicates the number of bits expressing each field and a “reference number” indicates matches to numbers within the brackets “( )” illustrated in FIG. 6A. For example, “(2)” illustrated in FIG. 6A indicates that the values recorded in the OFFSET_NUM field, the QUANT_NUM field, the BIT_DEPTH_PIXEL field, the OFFSET_TAB_Y field, the QUANT_TAB_Y field, the OFFSET_TAB_UV field, and the QUANT_TAB_UV field are changed in each number of BIT_DEPTH_REF_DEC field, and such changes can be expressed as a portion corresponding to the reference number “(2)” of FIG. 6B in the form of a pseudo code.

FIG. 6C illustrates two examples, (1) and (2), of the structures of the bit resolution adjustment information illustrated in FIGS. 6A and 6B. Each of examples (1) and (2) illustrated in FIG. 6C may be a structure of bit resolution adjustment information updated for each bitstream if “1” is recorded in the QMAP_PRESENT field or may be a structure of previously fixed bit resolution adjustment information if “0” is recorded in the QMAP_PRESENT field. Comparing example (1) with example (2) illustrated in FIG. 6C, a reduction recorded in a BIT_DEPTH_REF_DEC field of example (1) is 4 and a reduction recorded in a BIT_DEPTH_REF_DEC field of example (2) is 2. Thus, it can be seen that values recorded in a BIT_DEPTH_PIXEL field, an OFFSET_TAB_Y field, a QUANT_TAB_Y field, an OFFSET_TAB_UV field, and a QUANT_TAB_UV field of example (1) are mostly different from those of example (2).

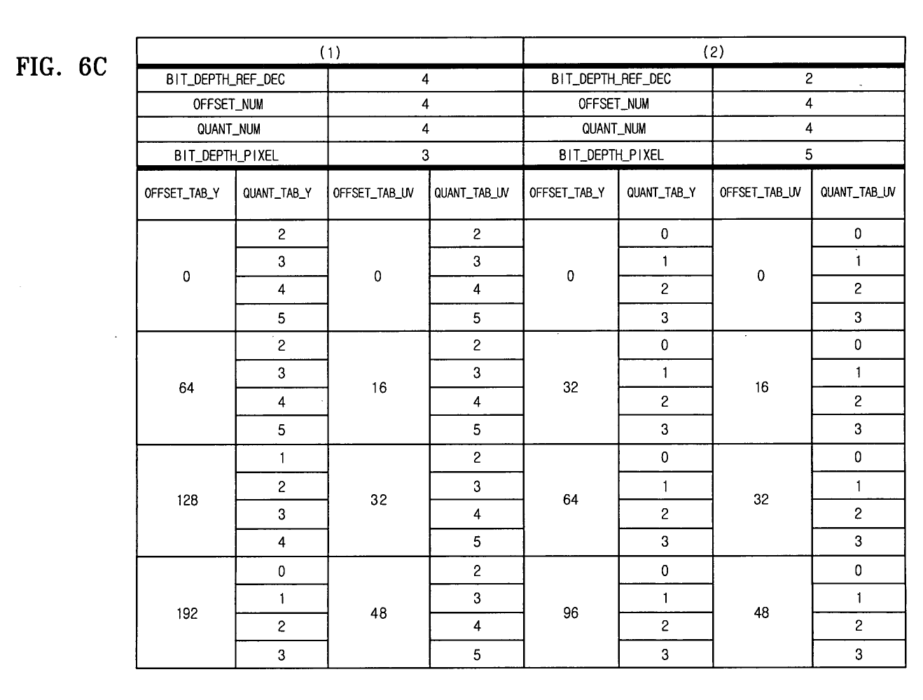

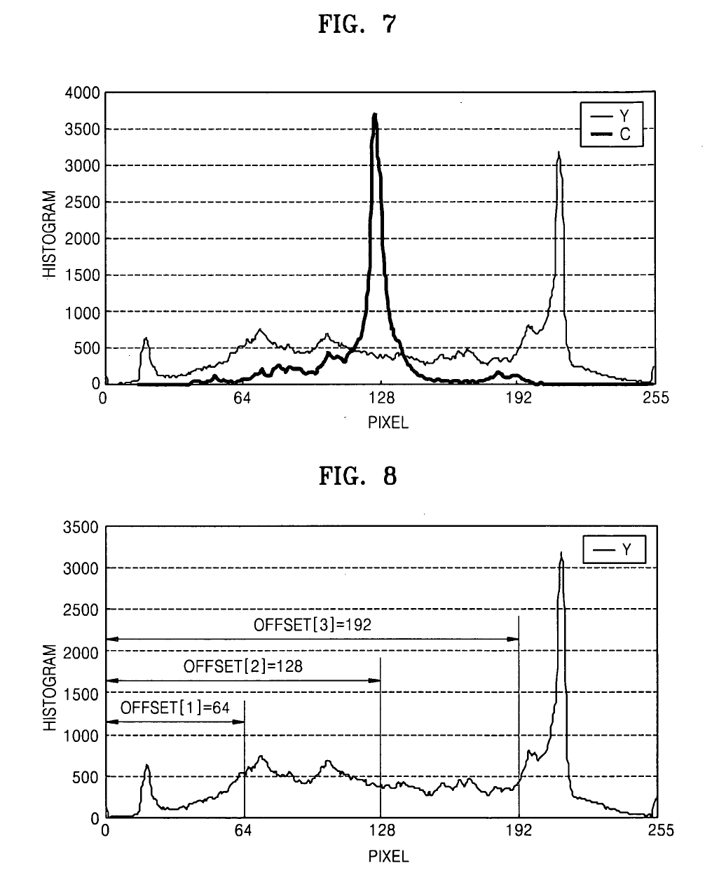

FIG. 7 is a histogram of a luminance component and a chrominance component of a general image. As can be seen from FIG. 7, color values corresponding to the luminance component are uniformly distributed over a large area while color values corresponding to the chrominance component are concentrated around an intermediate value of 128.

FIG. 8 is a diagram for explaining the definition of offset values for a luminance component illustrated in example (1) of FIG. 6C. In this embodiment, by using a general image feature that color values corresponding to a luminance component are distributed uniformly over a large area, 4 offset values for a luminance component may be defined as being distributed uniformly over the entire range of 0-255 as illustrated in example (1) of FIG. 6C. However, the definition of offset values may be changed based on the features of a particular image in order to achieve efficient quantization.

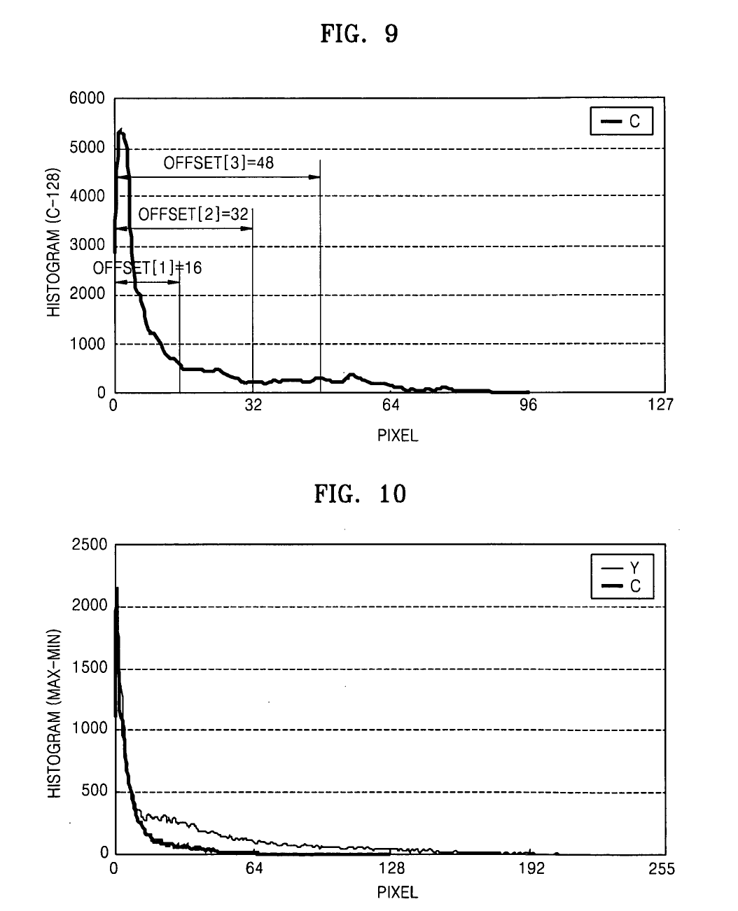

FIG. 9 is a diagram for explaining the definition of offset values for a chrominance component illustrated in example (1) of FIG. 6C. In this embodiment, by using a general image feature that color values corresponding to a chrominance component are concentrated around a value of 128, color values corresponding to the chrominance component are expressed with absolute values of results obtained by subtracting 128 from the color values and signs for the absolute values, and 4 offset values for the chrominance component are defined as being concentrated around 0.

FIG. 10 is a histogram of differences between maximum values and minimum values of each of a luminance component and a chrominance component of a 2×2 block in a general image. As can be seen from FIG. 10, the differences are concentrated around 0. Thus, image compression according an embodiment may properly express a value of each pixel with a small number of bits. In particular, if offset values are defined so that a value of each of the pixels making up an image can be distributed over the entire range of the offset values with a similar probability for the interval of each offset value based on the features of the image, according to this embodiment, a high quality reconstruction image can be generated even when a value of each pixel is expressed with a small number of bits.

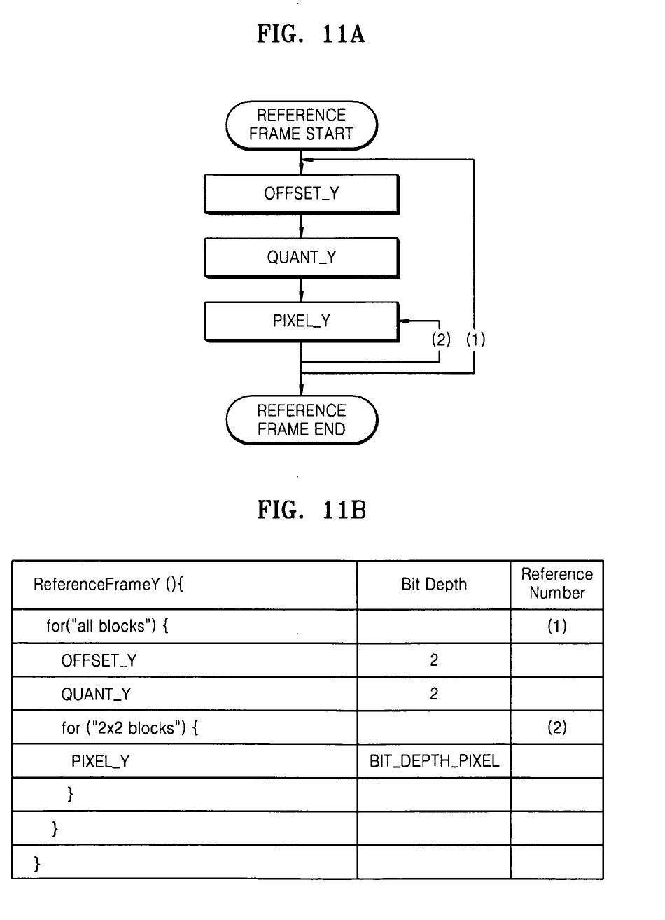

FIG. 11A illustrates a structure of a reference image of a luminance component compressed according to an embodiment of the present invention. Referring to FIG. 11A, the reference image of the luminance component may include an OFFSET_Y field, a QUANT_Y field, and a PIXEL_Y field. In particular, in this example, the reference image of the luminance component illustrated in FIG. 11A is structured so that each field is repeated. To reflect this structure, the structure of the reference image is illustrated in the form of a flowchart.

Here, an offset value for a luminance component of each 2×2 block is recorded in the OFFSET_Y field. A quantization size for a luminance component of each 2×2 block is recorded in the QUANT_Y field. A Y color value, which is a luminance component of each of 4 pixels making up each 2×2 block, is recorded in the PIXEL_Y field. In other words, a Y color value, which is a luminance component of each pixel whose bit resolution is reduced according to the offset value recorded in the OFFSET_Y field and the quantization size recorded in the QUANT_Y field, is recorded in the PIXEL_Y field.

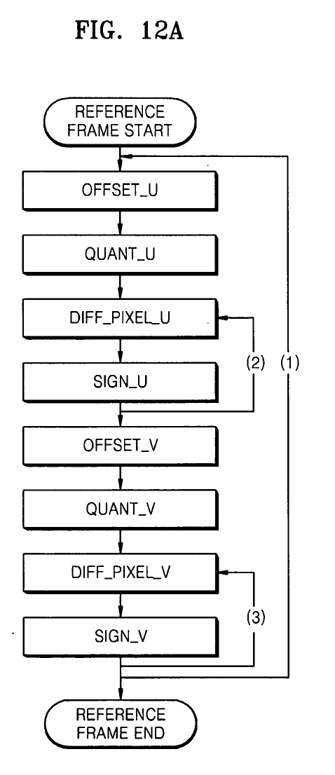

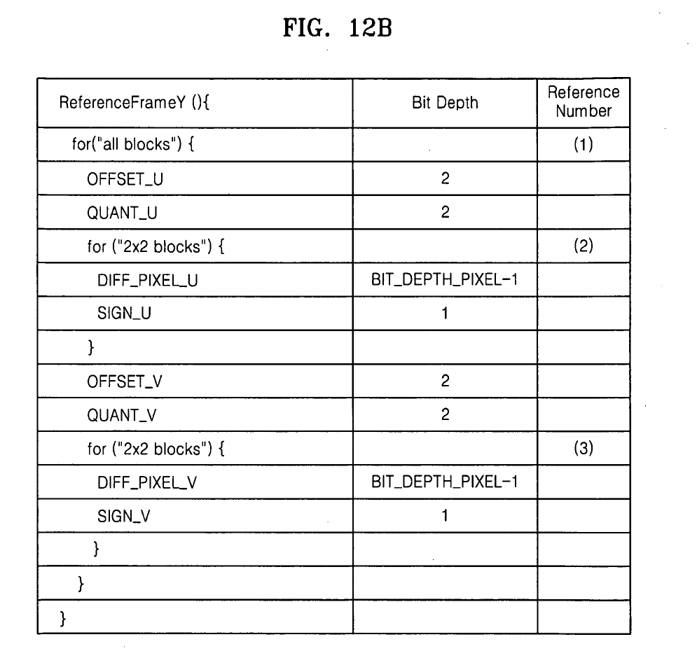

FIG. 11B illustrates the structure of the reference image of the luminance component illustrated in FIG. 11A in the form of a pseudo code. Among the items of the table illustrated in FIG. 11B, a “bit depth” indicates the number of bits expressing each field and a “reference number” indicates matches to numbers within the brackets “( )” illustrated in FIG. 11A. For example, “(2)” illustrated in FIG. 11A indicates that the PIXEL_Y field is repeated for each of 4 pixels of a 2×2 block, and such repetitions can be expressed as a portion corresponding to the reference number “(2)” of FIG. 11B in the form of a pseudo code. compressed according to an embodiment of the present invention. Referring to FIG. 12A, the reference image of the chrominance component includes an OFFSET_U field, a QUANT_U field, a DIFF_PIXEL_U field, a SIGN_U field, an OFFSET_V field, a QUANT_V field, a DIFF_PIXEL_V field, and a SIGN_V field. In particular, the reference image of the compressed chrominance component illustrated in FIG. 12A is structured in such a manner that each of the fields is repeated. To reflect this structure, the structure of the reference image is illustrated in the form of a flowchart.

Here, an offset for a Cb color as a chrominance component of each 2×2 block is recorded in the OFFSET_U field. A quantization size for the Cb color as a chrominance component of each 2×2 block is recorded in the QUANT_U field. An absolute value of a value obtained by subtracting 128 from the Cb color as a chrominance component of each of 4 pixels making up each 2×2 block is recorded in the DIFF_PIXEL_U field. A sign of the value obtained by subtracting 128 from the Cb color as a chrominance component of each of 4 pixels making up each 2×2 block is recorded in the SIGN_U field. In other words, the absolute value of the value obtained by subtracting 128 from the Cb color of each pixel whose bit resolution is reduced according to the offset value recorded in the OFFSET_U field and the quantization size recorded in the QUANT_U field is recorded in the DIFF_PIXEL_U field and the sign of the value obtained by subtracting 128 from the Cr color of each pixel whose bit resolution is reduced is recorded in the SIGN_U field.

An offset value for a Cr color as a chrominance component of each 2×2 block is recorded in the OFFSET_V field. A quantization size for the Cr color as a chrominance component of each 2×2 block is recorded in the QUANT_V field. An absolute value of a value obtained by subtracting 128 from the Cr color as a chrominance component of each of 4 pixels making up each 2×2 block is recorded in the DIFF_PIXEL_V field. A sign of the value obtained by subtracting 128 from the Cr color as a chrominance component of each of 4 pixels making up each 2×2 block is recorded in the SIGN_V field. In other words, the absolute value of the value obtained by subtracting 128 from the Cr color of each pixel whose bit resolution is reduced according to the offset value recorded in the OFFSET_V field and the quantization size recorded in the QUANT_V field is recorded in the DIFF_PIXEL_V field and the sign of the value obtained by subtracting 128 from the Cr color of each pixel whose bit resolution is reduced is recorded in the SIGN_V field.

Referring to FIGS. 6A through 6C, for both the Cb color and the Cr color, in this embodiment, values to be recorded in the OFFSET_U field and the QUANT_U field for Cb color and the OFFSET_V field and the QUANT_V field for Cr color are selected from values recorded in the OFFSET_TAB_UV field and the QUANT_TAB_UV field.

FIG. 12B illustrates the structure of the reference image of the chrominance component illustrated in FIG. 12A in the form of a pseudo code. Among the items of the table illustrated in FIG. 12B, a “bit depth” indicates the number of bits expressing each field and a “reference number” indicates matches to numbers within the brackets “( )” illustrated in FIG. 12A. For example, “(2)” illustrated in FIG. 12A indicates that the DIFF_PIXEL_U field and the SIGN_U field are repeated for each of 4 pixels of a 2×2 block, and such repetitions can be expressed as a portion corresponding to the reference number “(2)” of FIG. 12B in the form of a pseudo code.

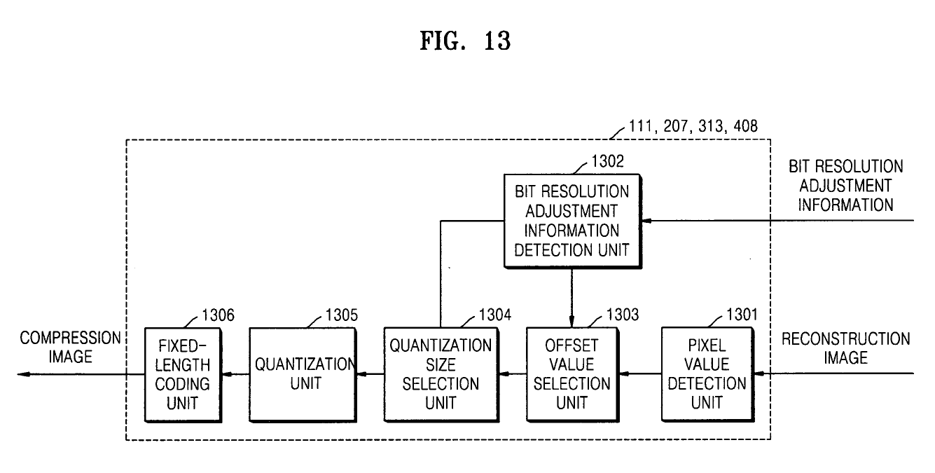

FIG. 13 is a block diagram of an apparatus compressing an image, according to an embodiment of the present invention. In an embodiment, the apparatus illustrated in FIG. 13 corresponds to the compression unit 111 illustrated in FIG. 1, the compression unit 207 illustrated in FIG. 2, the compression unit 313 illustrated in FIG. 3, and the compression unit 408 illustrated in FIG. 4, for example. Referring to FIG. 13, such a compressing apparatus may include a pixel value detection unit 1301, a bit resolution adjustment information detection unit 1302, an offset value selection unit 1303, a quantization size selection unit 1304, a quantization unit 1305, and a fixed-length coding unit 1306, for example.

The pixel value detection unit 1301 may detect a minimum value and a maximum value, for example, from among values of pixels making up each 2×2 block of a reconstruction image. For example, it is assumed that a value of each of the pixels is composed of a Y color value, a Cb color value, and a Cr color value. In this case, for Y color values, the pixel value detection unit 1301 may detect a minimum Y color value and a maximum Y color value from among Y color values of pixels of a 2×2 block of the reconstruction image. Similarly, the pixel value detection unit 1301 may detect a minimum color value and a maximum color value for both the Cb color values and Cr color values.

The bit resolution adjustment information detection unit 1302 may further detect bit resolution adjustment information of the reconstruction image. For example, if the bit resolution adjustment information is stored in an external memory, the bit resolution adjustment information detection unit 1302 may detect the bit resolution adjustment information of the reconstruction image by reading the stored bit resolution adjustment information from the external memory. Similarly, if the bit resolution adjustment information has been recorded in a frame header, the bit resolution adjustment information detection unit 1302 reads the bit resolution adjustment information from the frame header, thereby detecting the bit resolution adjustment information of the reconstruction image.

The offset value selection unit 1303 may accordingly select an offset value for an example 2×2 block of the reconstruction image from among a plurality of offset values contained in the bit resolution adjustment information detected by the bit resolution adjustment information detection unit 1302 based on values of pixels making up the 2×2 block. More specifically, in an embodiment, the offset value selection unit 1303 selects an offset value that is closest to, but less than, the minimum value detected by the pixel value detection unit 1301 from among the plurality of offset values. For example, if the bit resolution adjustment information detected by the bit resolution adjustment information detection unit 1302 is the same as example (1) of FIG. 6C and the minimum value detected by the pixel value detection unit 1301 is “100”, the offset value selection unit 1303 selects “64” from among the offset values shown in example (1) of FIG. 6C.

In such an embodiment, the quantization size selection unit 1304 selects a quantization size of a 2×2 block of the reconstruction image from among a plurality of quantization sizes contained in the bit resolution adjustment information detected by the bit resolution adjustment information detection unit 1302 based on values of pixels making up the 2×2 block. More specifically, here, the quantization size selection unit 1304 selects a quantization size that is closest to the minimum number of bits that can express a difference between the offset value selected by the offset value selection unit 1303 and the maximum value detected by the pixel value detection unit 1301 from among the plurality of quantization sizes. In this example, if the maximum value detected by the pixel value detection unit 1301 is “150”, the difference between the offset value selected by the offset value selection unit 1303 and the maximum value detected by the pixel value detection unit 1301 is “86”. Since the minimum number of bits that can express the difference “86” is 7 bits and each pixel has to be represented by 3 bits, the quantization size selection unit 1304 selects “4” as the quantization size from among the quantization sizes shown in example (1) of FIG. 6C.

The quantization unit 1305 may further calculate differences between values of pixels of an example 2×2 block of the reconstruction image and the offset value selected by the offset value selection unit 1303 using the below Equation 1, for example, and divide the calculated differences by the quantization size selected by the quantization size selection unit 1304, thereby reducing the number of bits expressing the differences by the quantization size selected by the quantization size selection unit 1304.

Y=(X−offset_value+f)>>Q Equation 1:

Here, “Y” indicates a quantization value of a color value of each pixel, “X” indicates a color value of each pixel, and “offtset_value ” indicates an offset value of each 2×2 block. “>>Q” is referred to as an operation of division by “2^{Q}” and actually means a right bit shift operation by “Q”. In addition, “f” is a rounding value for rounding off a result of dividing X−offset_value” by “Q”. In other words, f=0 for Q=0 and f=1<<(Q−1) for Q>1. In the above example, the quantization unit 1305 divides the differences by “16” derived from the quantization size “4” selected by the quantization size selection unit 1304, thereby reducing the number of bits expressing the differences, i.e., 8 bits, by the quantization size “4” selected by the quantization size selection unit 1304. As a result, the differences of 8 bits are expressed as the differences of 4 bits.

However, according to an embodiment of the present invention, color values corresponding to a chrominance component from among values of pixels a 2×2 block of the reconstruction image may be expressed with absolute values of values obtained by subtracting 128 from the color values and signs. Thus, here, the quantization unit 1305 calculates differences between the absolute values of the values obtained by subtracting 128 from the color values and the offset value selected by the offset value selection unit 1303 and divides the calculated differences by the quantization size selected by the quantization size selection unit 1304, thereby reducing the number of bits that express the differences by the quantization size selected by the quantization size selection unit 1304.

The fixed-length coding unit 1306 performs fixed-length coding on quantization results of pixels, obtained by the quantization unit 1305, and combines fixed-length coding values obtained by the fixed-length coding unit 1306, the offset value selected by the offset value selection unit 1303, and the quantization size selected by the quantization size selection unit 1304, in order to generate a 2×2 block of a fixed-length, and stores the generated 2×2 block in each of the memories 113, 209, 315, and 410, for example. More specifically, in an embodiment, the fixed-length coding unit 1306 extracts bits corresponding to the actual bit size recorded in the BIT_DEPTH_PIXEL field of the bit resolution adjustment information detected by the bit resolution adjustment information detection unit 1302 from bits expressing a quantization result of each pixel obtained by the quantization unit 1305, starting from a most significant bit, combines fixed-length bits indicating a fixed-length coding value of each pixel, fixed-length bits indicating the offset value selected by the offset value selection unit 1303, and fixed-length bits indicating the quantization size selected by the quantization size selection unit 1304 in order to generate a 2×2 block of a fixed-length and stores the generated 2×2 block in each of the memories 113, 209, 315, and 410, for example.

In the above example, considering one color value, the fixed-length coding unit 1306 extracts bits corresponding to an actual bit size recorded in the BIT_DEPTH_PIXEL field of the bit resolution adjustment information detected by the bit resolution adjustment information detection unit 1302, i.e., 3 bits, from 6 bits expressing a quantization result of each pixel obtained by the quantization unit 1305, starting from a most significant bit, combines the extracted 3 bits indicating a fixed-length coding value of each pixel, i.e., a total of 12 bits for the 2×2 block, 2 bits indicating the offset value selected by the offset value selection unit 1303, and 2 bits indicating the quantization size selected by the quantization size selection unit 1304, thereby generating a 16-bit 2×2 block of the compression image. Since such a result is based on only one of three color values, a 2×2 block of 48 bits can be generated based on the three color values.

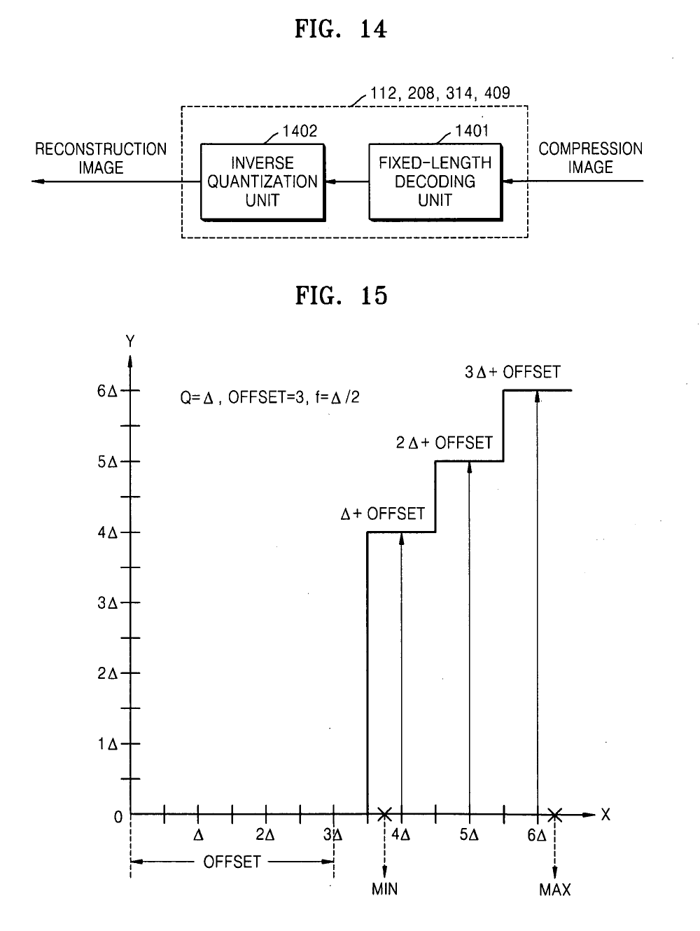

FIG. 14 is a block diagram of an apparatus for reconstructing an image, according to an embodiment of the present invention. In particular, the apparatus illustrated in FIG. 14 may correspond to each of the reconstruction units 112, 208, 314, and 409, for example. Referring to FIG. 14, the apparatus according to an embodiment of the present invention, may include a fixed-length decoding unit 1401 and an inverse quantization unit 1402, for example.

The fixed-length decoding unit 1401 reads a compression image stored in each of the memories 113, 209, 315, and 410, for example, in units of 2×2 blocks, extracts an offset value of a read 2×2 block, a quantization size of the 2×2 block, and fixed-length coding values of pixels making up the 2×2 block from the read 2×2 block, and performs fixed-length decoding on the extracted fixed-length coding values, thereby reconstructing a quantization value of each of the pixels. More specifically, in an embodiment, the fixed-length decoding unit 1401 can increase the number of bits indicating the quantization value of each of the pixels based on the number of bits indicating the quantization value of each of the pixels and the quantization size of the 2×2 block, thereby reconstructing the quantization value of each of the pixels.

In the above example, considering one color value, the fixed-length decoding unit 1401 extracts an offset value of 2 bits, a quantization size of 2 bits, and a 3-bit value of each of 4 pixels, and increases the number of bits indicating a value of each of the pixels, i.e., 3 bits, to 7 bits, based on the number of bits (=3) indicating a value of each of the pixels and the quantization size (=4) of the 2×2 block, thereby reconstructing the quantization value of each of the pixels.

By using the below Equation 2, for example, the inverse quantization unit 1402 multiplies the quantization size extracted by the fixed-length decoding unit 1401 by the quantization value of each pixel reconstructed by the fixed-length decoding unit 1401 and sums a multiplication result and the offset value extracted by the fixed-length decoding unit 1401, thereby reconstructing original bits of each pixel.

X′=(Y<<Q)+offset_value Equation 2:

Here, “X” indicates a reconstruction color value of each pixel, “Y” indicates a quantization value of a color value of each pixel, and “<<Q ” is referred to as an operation of multiplication by “2^{Q}” and actually means a left bit shift operation by “Q”. “offset value” indicates an offset value of each 2×2 block. In the above example, the inverse quantization unit 1402 multiplies the quantization value of each pixel by “16” derived from the quantization size “4” extracted by the fixed-length decoding unit 1401 and sums a multiplication result and the offset value “64” extracted by the fixed-length, decoding unit 1401, thereby reconstructing 8 bits of each pixel.

However, according to an embodiment of the present invention, color values corresponding to a chrominance from among values of pixels making up a 2×2 block of a reconstruction image may be expressed with absolute values of values obtained by subtracting 128 from the color values and signs. Thus, the inverse quantization unit 1402 may multiply quantization values corresponding to a chrominance component from among quantization values of pixels reconstructed by the fixed-length decoding unit 1401 by the quantization size extracted by the fixed-length decoding unit 1401 and sum a multiplication result and the offset value extracted by the fixed-length decoding unit 1401, thereby reconstructing absolute values of values obtained by subtracting 128 from the color values corresponding to the chrominance component from among original bits of each of the pixels.

FIG. 15 illustrates an example of a relationship between a value that is input to the quantization unit 1305 illustrated in FIG. 13 and a value that is reconstructed by the inverse quantization unit 1402 illustrated in FIG. 14. In FIG. 15, from among values of pixels of a 2×2 block, a minimum value exists between 3Δ and 4Δ and a maximum value exists between 6Δ and 7Δ. 3Δ is selected as an offset value, Δ is selected as a quantization size, and f is Δ/2. Referring to FIG. 15, if a value input to the quantization unit 1305 exists between the minimum value and 4.5Δ, a value reconstructed by the inverse quantization unit 1402 is (Δ+offset value). For the input value between 4.5Δ and 5.5Δ, the reconstructed value is (2Δ+offset value). For the input value between 5.5Δ and the maximum value, the reconstructed value is (3Δ+offset value).

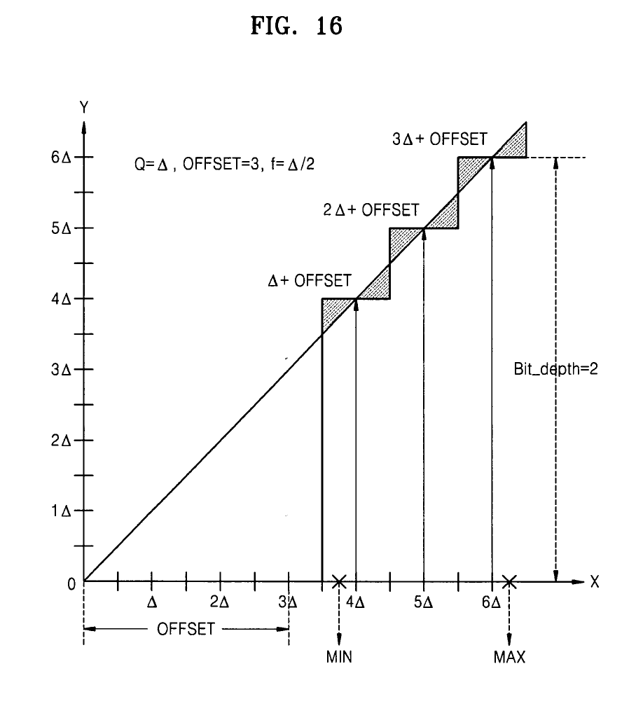

FIG. 16 illustrates an example of a quantization error between the value that is input to the quantization unit 1305 illustrated in FIG. 13 and the value that is reconstructed by the inverse quantization unit illustrated 1402 in FIG. 14. In FIG. 16, from among values of pixels of a 2×2 block, a minimum value exists between 3Δ and 4Δ and a maximum value exists between 6Δ and 7Δ. 3Δ is selected as an offset value, A is selected as a quantization size, and f is Δ/2. In such a quantization environment, if a bit resolution of each pixel is 2, shadow regions in FIG. 16 correspond to the quantization error between the value that is input to the quantization unit 1305 and the value that is reconstructed by the inverse quantization unit 1402.

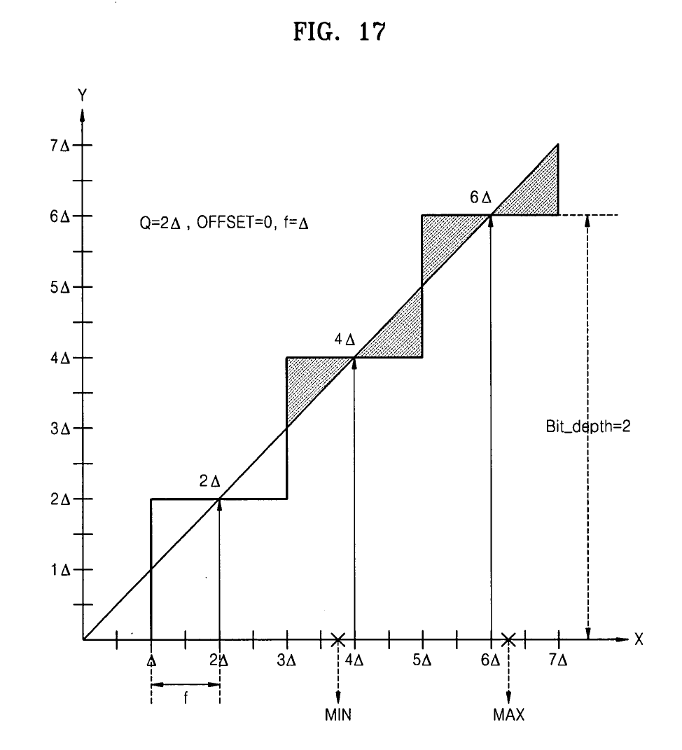

FIG. 17 illustrates another example of a quantization error between a value input to the quantization unit 1305 illustrated in FIG. 13 and the value that is reconstructed by the inverse quantization unit illustrated 1402 in FIG. 14. In FIG. 17, from among values of pixels of a 2×2 block, a minimum value exists between 3Δ and 4Δ and a maximum value exists between 6Δ and 7Δ. 0 is selected as an offset value, 2Δ is selected as a quantization size, and f is Δ. In such a quantization environment, if a bit resolution of each pixel is 2, shadow regions in FIG. 17 correspond to the quantization error between the value that is input to the quantization unit 1305 and the value that is reconstructed by the inverse quantization unit 1402. Referring to FIG. 17, the quantization size is greater than that in FIG. 16, thus increasing the quantization error.

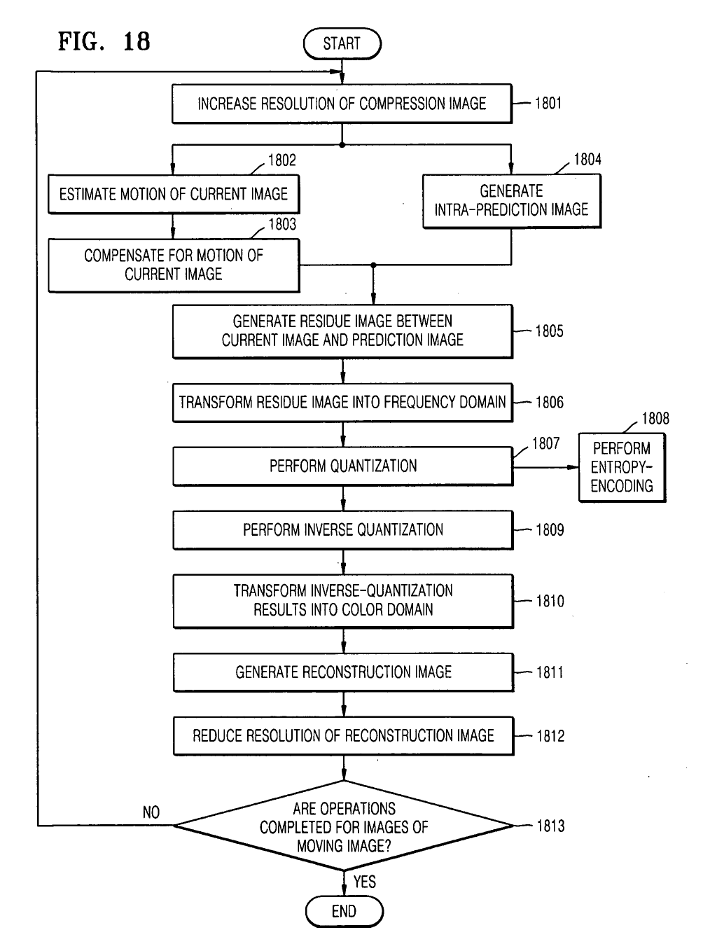

FIG. 18 is a flowchart illustrating a method of encoding a moving image, according to an embodiment of the present invention. As only one example, such an embodiment may correspond to example sequential processes of the example apparatus 10 illustrated in FIG. 1, but is not limited thereto and alternate embodiments are equally available. Regardless, this embodiment will now be briefly described in conjunction with FIG. 1, with repeated descriptions thereof being omitted.

In operation 1801, the apparatus 10 may increase the resolution of a compression image corresponding to a reference image of a current image from among compression images stored in the memory 113, thereby reconstructing the reference image of the current image. In operation 1802, the apparatus 10 estimates a motion of the current image from among images of a moving image based on the reference image reconstructed in operation 1801. In operation 1803, the apparatus 10 generates a prediction image of the current image from the reference image reconstructed in operation 1801 by using motion vector estimated in operation 1802.

In operation 1804, for each of the blocks corresponding to an intra mode from among all blocks of the current image, the apparatus 10 predicts a value of the block of the current image from a value of a block of a reconstruction image, which is located adjacent to the block of the current image, from among all blocks of the reconstruction image, thereby generating a prediction image of the current image. In operation 1805, the apparatus 10 subtracts the prediction image generated in operation 1803 or 1804 from the current image, thereby generating a residue image between the current image and the prediction image.

In operation 1806, the apparatus 10 transforms the residue image generated in operation 1805 from a color domain into a frequency domain. In operation 1807, the apparatus 10 quantizes transformation results obtained in operation 1806. In operation 1808, the apparatus 10 entropy-encodes quantization results obtained in operation 1807, thereby generating a bitstream.

In operation 1809, the apparatus 10 inversely quantizes the quantization results obtained in operation 1807. In operation 1810, the apparatus 10 transforms inverse-quantization results obtained in operation 1809, i.e., frequency component values, from the frequency domain into the color domain, thereby reconstructing the residue image between the current image and the prediction image. In operation 1811, the apparatus 10 adds the residue image reconstructed in operation 1812 to the prediction image generated in operation 1803 or 1804, thereby generating a reconstruction image.

In operation 1812, the apparatus 10 compresses the reconstruction image generated in operation 1811 by reducing a resolution of the reconstruction image and stores the compressed reconstruction image, i.e., a compression image, in the memory 113. In operation 1813, the apparatus 10 terminates operation if operations 1801 through 1812 have been completed for all images of a moving image. Otherwise, the apparatus 10 repeats operations 1801 through 1812 for an image following the current image.

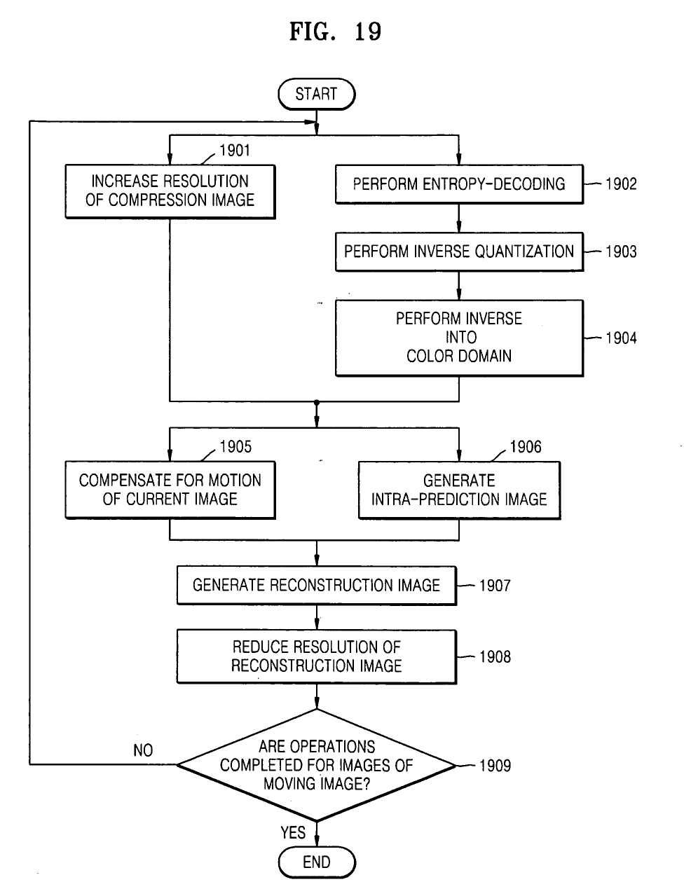

FIG. 19 is a flowchart illustrating a method of decoding a moving image, according to an embodiment of the present invention. As only one example, such an embodiment may correspond to example sequential processes-of the example apparatus 20 illustrated in FIG. 2, but is not limited thereto and alternate embodiments are equally available. Regardless, this embodiment will now be briefly described in conjunction with FIG. 2, with repeated descriptions thereof being omitted.

In operation 1901, the apparatus 20 increases a resolution of a compression image corresponding to a reference image of a current image from among compression images stored in the memory 209, thereby reconstructing the reference image of the current image.

In operation 1902, the apparatus 20 entropy-decodes a bitstream, such as a bitstream output from the apparatus 10 illustrated in FIG. 1, thereby reconstructing integers corresponding to a moving image and information required to decode the moving image. In operation 1903, the apparatus 20 inversely quantizes the integers reconstructed in operation 1902, thereby reconstructing frequency component values. In operation 1904, the apparatus 20 transforms the frequency component values reconstructed in operation 1903 from the frequency domain into the color domain, thereby reconstructing a residue image between the current image and a prediction image.

In operation 1905, the apparatus 20 generates the prediction image of the current image from the reference image reconstructed in operation 1901 by using motion vector for the current image estimated based on the reconstructed reference image. In operation 1906, for each of the blocks corresponding to an intra mode from among all blocks making up the current image, the apparatus 20 predicts a value of the block of the current image from a value of a block of a reconstruction image, which is located adjacent to the block of the current image, from among all blocks of the reconstruction image, thereby generating a prediction image of the current image. In operation 1907, the apparatus 20 adds the residue image reconstructed in operation 1904 to the prediction image generated in operation 1905 or 1906, thereby generating a reconstruction image of the current image.

In operation 1908, the apparatus 20 compresses the reconstruction image generated in operation 1907 by reducing a resolution of the reconstruction image and stores the compressed reconstruction image, i.e., a compression image, in the memory 209. In operation 1909, the apparatus 20 terminates operation if operations 1901 through 1908 have been completed for all images of a moving image. Otherwise, the apparatus 20 repeats operations 1901 through 1908 for an image following the current image.

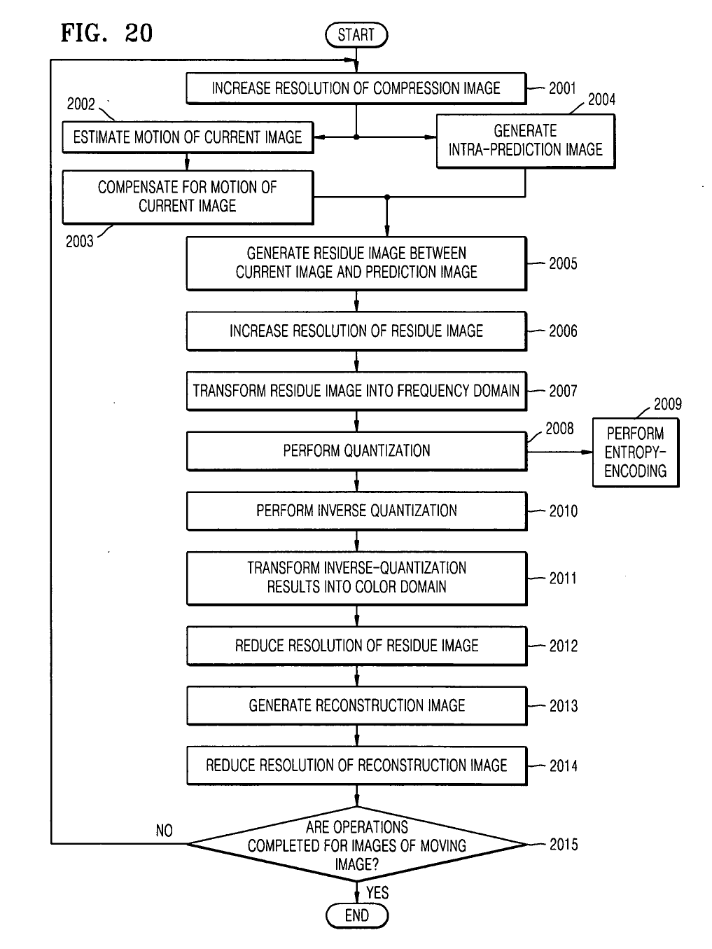

FIG. 20 is a flowchart illustrating a method of encoding a moving image, according to an embodiment of the present invention. As only one example, such an embodiment may correspond to example sequential processes of the example apparatus 30 illustrated in FIG. 3, but is not limited thereto and alternate embodiments are equally available. Regardless, this embodiment will now be briefly described in conjunction with FIG. 3, with repeated descriptions thereof being omitted.

In operation 2001, the apparatus 30 increases a resolution of a compression image corresponding to a reference image of a current image from among compression images stored in the memory 315, thereby reconstructing the reference image of the current image. In operation 2002, the apparatus 30 estimates a motion of the current image from among images of a moving image based on the reference image reconstructed in operation 2001. In operation 2003, the apparatus 30 generates a prediction image of the current image from the reference image reconstructed in operation 2001 by using a motion vector for the current image estimated in operation 2002.

In operation 2004, for each of the blocks corresponding to an intra mode from among all blocks of the current image, the apparatus 30 predicts a value of the block of the current image from a value of a block of a reconstruction image, which is located adjacent to the block of the current image, from among all blocks of the reconstruction image, thereby generating a prediction image of the current image. In operation 2005, the apparatus 30 subtracts the prediction image generated in operation 2003 or 2004 from the current image, thereby generating a residue image between the current image and the prediction image.

In operation 2006, the apparatus 30 increases a resolution of the residue image generated in operation 2005. In operation 2007, the apparatus 30 transforms the residue image whose resolution is increased in operation 2006 from the color domain into the frequency domain. In operation 2008, the apparatus 30 quantizes transformation results obtained in operation 2007. In operation 2009, the apparatus 30 entropy-encodes quantization results obtained in operation 2008, thereby generating a bitstream.

In operation 2010, the apparatus 30 inversely quantizes the quantization results obtained in operation 2008. In operation 2011, the apparatus 30 transforms inverse-quantization results obtained in operation 2010, i.e., frequency component values, from the frequency domain into the color domain, thereby reconstructing a residue image between the current image and the prediction image.

In operation 2012, the apparatus 30 reduces a resolution of the residue image reconstructed in operation 2011. In operation 2013, the apparatus 30 adds the residue image whose resolution is reduced in operation 2012 to the prediction image generated in operation 2003 or 2004, thereby generating a reconstruction image of the current image. In operation 2014, the apparatus 30 compresses the reconstruction image generated in operation 2013 by reducing a resolution of the reconstruction image and stores the compressed reconstruction image in the memory 315. In operation 2015, the apparatus 30 terminates operation if operations 2001 through 2014 have been completed for all images of a moving image. Otherwise, the apparatus 30 repeats operations 2001 through 2014 for an image following the current image.

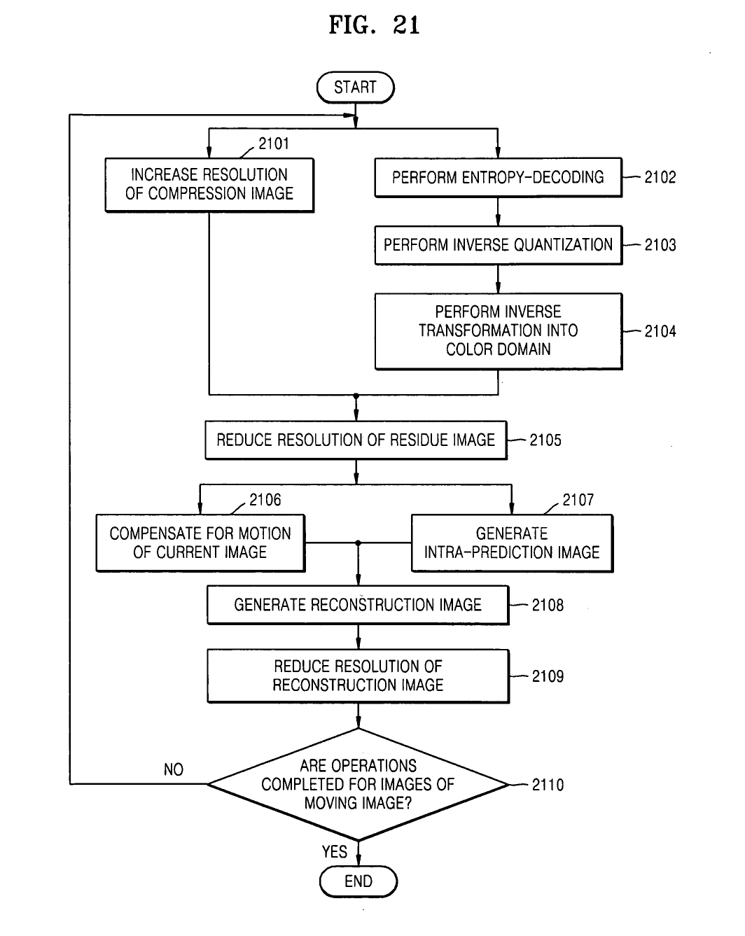

FIG. 21 is a flowchart illustrating a method of decoding a moving image, according to an embodiment of the present invention. As only one example, such an embodiment may correspond to example sequential processes of the example apparatus 40 illustrated in FIG. 4, but is not limited thereto and alternate embodiments are equally available. Regardless, this embodiment will now be briefly described in conjunction with FIG. 4, with repeated descriptions thereof being omitted.

In operation 2101, the apparatus 40 increases a resolution of a compression image corresponding to a reference image of a current image from among compression images stored in the memory 410, thereby reconstructing the reference image of the current image.

In operation 2102, the apparatus 40 entropy-decodes a bitstream, e.g., as generated and output from the apparatus 30 illustrated in FIG. 3, thereby reconstructing integers corresponding to a moving image and information required to decode the moving image. In operation 2103, the apparatus 40 inversely quantizes the integers reconstructed in operation 2102, thereby reconstructing frequency component values. In operation 2104, the apparatus 40 transforms the frequency component values reconstructed in operation 2103 from the frequency domain into the color domain, thereby reconstructing a residue image between the current image and a prediction image.

In operation 2105, the apparatus 40 reduces a resolution of the residue image reconstructed in operation 2104.

In operation 2106, the apparatus 40 generates the prediction image of the current image from at least one reference image by using a motion vector for the current image estimaged based on the reference image reconstructed in operation 2101. In operation 2107, for each of the blocks corresponding to an intra mode from among all blocks making up the current imager the apparatus 40 predicts a value of the block of the current image from a value of a block of a reconstruction image, which is located adjacent to the block of the current image, from among ail blocks of the reconstruction image, thereby generating a prediction image of the current image. In operation 2108, the apparatus 40 adds the residue image whose resolution is reduced in operation 2105 to the prediction image generated in operation 2106 or 2107, thereby generating a reconstruction image of the current image.

In operation 2109, the apparatus 40 compresses the reconstruction image generated in operation 2108 by reducing a resolution of the reconstruction image and stores the compressed reconstruction image, i.e., a compression image, in the memory 410. In operation 2110, the apparatus 40 terminates operation if operations 2101 through 2109 have been completed for all images of a moving image. Otherwise, the apparatus 40 repeats operations 2101 through 2109 for an image following the current image.

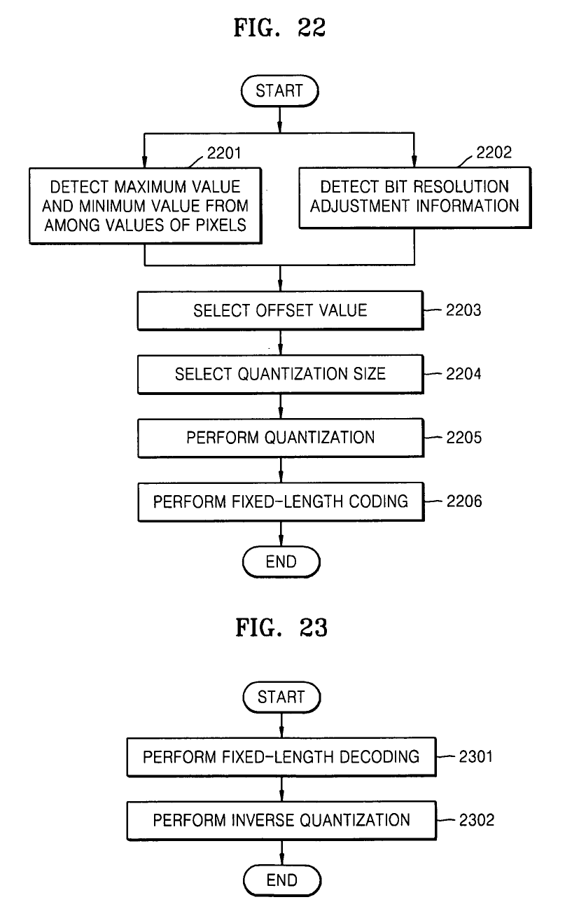

FIG. 22 is a flowchart illustrating a method of compressing an image, according to an embodiment of the present invention. As an example, the method illustrated in FIG. 22 corresponds to operation 1812 illustrated in FIG. 18, operation 1908 illustrated in 19, operation 2014 illustrated in 20, and operation 2109 illustrated in FIG. 21. Referring to FIG. 22, such a method, e.g., operations 1812, 1908, 2014, and 2109 illustrated in FIGS. 18 through 21, may correspond to example sequential processes of the example apparatus illustrated in FIG. 13, but is not limited thereto and alternate embodiments are equally available. Regardless, this embodiment will now be briefly described in conjunction with FIG. 13, with repeated descriptions thereof being omitted.

In operation 2201, the apparatus for compressing an image detects a minimum value and a maximum value from among values of pixels making up a 2×2 block of a reconstruction image.

In operation 2202, the apparatus detects bit resolution adjustment information of the reconstruction image. In operation 2203, the apparatus selects an offset value for the 2×2 block from among a plurality of offset values included in the bit resolution adjustment information detected in operation 2202 based on the values of the pixels of the 2×2 block.

In operation 2204, the apparatus selects a quantization size for the 2×2 block from among a plurality of quantization sizes included in the bit resolution adjustment information detected in operation 2202 based on the values of the pixels of the 2×2 block.

In operation 2205, the apparatus calculates differences between the values of the pixels of the 2×2 block and the offset value selected in operation 2203 and divides the calculated differences by the quantization size selected in operation 2204, thereby reducing the number of bits indicating the differences by the quantization size selected in operation 2204.

In operation 2206, the apparatus performs fixed-length coding on quantization values of the pixels generated in operation 2205 and combines fixed-length coding values of the pixels, the offset value selected in operation 2203, and the quantization size selected in operation 2204, thereby generating a 2×2 block of a fixed-length.

FIG. 23 is a flowchart illustrating a method of reconstructing an image, according to an embodiment of the present invention. As an example, the method illustrated in FIG. 23 may correspond to operation 1801 illustrated in FIG. 18, operation 1901 illustrated in FIG. 19, operation 2001 illustrated in FIG. 20, and operation 2101 illustrated in FIG. 21. Referring to FIG. 23, such a method, e.g., operations 1801, 1901, 2001, and 2101 illustrated in FIGS. 18 through 21, may correspond to example sequential processes of the apparatus illustrated in FIG. 14, but is not limited thereto and alternate embodiments are equally available. Regardless, this embodiment will now be briefly described in conjunction with FIG. 14, with repeated descriptions thereof being omitted.

In operation 2301, the apparatus for reconstructing an image illustrated in FIG. 14 reads a compression image stored in each of the memories 113, 209, 315, and 410 in units of 2×2 blocks, for example, extracts an offset value of a read 2×2 block, a quantization size of the 2×2 block, and fixed-length coding values of pixels of the 2×2 block, and performs fixed-length decoding on the extracted fixed-length coding values, thereby reconstructing quantization values of the pixels.

In operation 2302, the apparatus multiplies the quantization values reconstructed in operation 2301 by the quantization size extracted in operation 2301 and sums a multiplication result and the offset value extracted in operation 2301, thereby reconstructing original bits of each of the pixels.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or controlling carrier waves as well as elements of the Internet, for example. Thus, the medium may be such a defined and measurable structure carrying or controlling a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of encoding a moving image, the method comprising:
reconstructing a reference image of a current image by increasing a resolution of a compression image corresponding to the reference image from a plurality of compression images stored in a memory;
encoding the current image by using the reconstructed reference image;
generating a reconstruction image of the current image by decoding the encoded current image; and
reducing a resolution of the generated reconstruction image to compress the reconstruction image and adding the compressed reconstruction image to the plurality of compression images in the memory.

2. The method of claim 1, wherein the resolution of the compression image and the resolution of the generated reconstruction image are bit resolutions indicating numbers of bits expressing color values of each pixel making up the compression image or the generated reconstruction image.

3. The method of claim 1, wherein the reducing of the resolution of the generated reconstruction image comprises determining a reduction amount for the reducing of the resolution in units of predetermined-size blocks and reducing the resolution of the generated reconstruction image by the determined reduction amount to compress the generated reconstruction image, and
the reconstructing of the reference image comprises determining an increase amount for the increasing of the resolution of the compression image in units of the predetermined-size blocks and increasing the resolution of the compression image by the determined increase amount.

4. The method of claim 1, wherein the reducing of the resolution of the generated reconstruction image comprises:
selecting an offset value that is closest to, but less than, a minimum value among values of pixels making up a predetermined-size block of the generated reconstruction image from among a plurality of offset values;
selecting a quantization size closest to a minimum number of bits that are sufficient to indicate a difference between the selected offset value and a maximum value among the values of the pixels, from among a plurality of quantization sizes; and
dividing differences between respective values of the pixels and the selected offset value by the selected quantization size to reduce the number of bits indicating the differences by the selected quantization size.

5. The method of claim 1, wherein the reconstructing of the reference image comprises:
extracting an offset value of a predetermined-size block of the compression image and a quantization value of each of plural pixels making up the block from the block of the compression image; and
multiplying a quantization value of each of the plural pixels by the extracted quantization size and summing a result of the multiplication and the extracted offset value to reconstruct original bits of each of the plural pixels.

6. An encoding apparatus, the apparatus comprising:
a reconstruction unit to reconstruct a reference image of a current image by increasing a resolution of a compression image corresponding to the reference image from a plurality of compression images stored in a memory;
an encoding unit to implement prediction encoding of the current image by using the reconstructed reference image;
a decoding unit to generate a reconstruction image of the current image by decoding the encoded current image; and
a compression unit to reduce a resolution of the generated reconstruction image to compress the reconstruction image and to add the compressed reconstruction image to the plurality of compression images in the memory.

7. A method of decoding a moving image, the method comprising:
reconstructing a reference image of a current image by increasing a resolution of a compression image corresponding to the reference image from among a plurality of compression images stored in a memory;
generating a reconstruction image of the current image by decoding a bitstream and applying the reconstructed reference image to the decoded bitstream; and
reducing a resolution of the generated reconstruction image to compress the reconstruction image and adding the compressed reconstruction image to the plurality of compression images in the memory.

8. The method of claim 7, wherein the resolution of the compression image and the resolution of the generated reconstruction image are bit resolutions indicating numbers of bits expressing color values of each pixel making up the compression image or the generated reconstruction image.

9. The method of claim 7, wherein the reducing of the resolution of the generated reconstruction image comprises determining a reduction amount for the reducing of the resolution in units of predetermined-size blocks and reducing the resolution of the generated reconstruction image by the determined reduction amount to compress the generated reconstruction image, and
the reconstructing of the reference image comprises determining an increase amount for the increasing of the resolution of the compression image in units of the predetermined-size blocks and increasing the resolution of the compression image by the determined increase amount.

10. The method of claim 7, wherein the reducing of the resolution of the generated reconstruction image comprises:
selecting an offset value of a predetermined-size block of the generated reconstruction image from among a plurality of offset values based on values of pixels making up the block;
selecting a quantization size of the block from among a plurality of quantization sizes based on the values of the pixels of the block; and
dividing differences between respective values of the pixels and the selected offset value by the selected quantization size to reduce a number of bits indicating the differences by the selected quantization size.

11. The method of claim 7, wherein the reconstructing of the reference image comprises:
extracting an offset value of a predetermined-size block of the compression image and a quantization value of each of plural pixels making up the block from the block of the compression image; and
multiplying a quantization value of each of the plural pixels by the extracted quantization size and summing a result of the multiplication and the extracted offset value to reconstruct original bits of each of the plural pixels.

12. A decoding apparatus, the apparatus comprising:
a reconstruction unit to reconstruct a reference image of a current image by increasing a resolution of a compression image corresponding to the reference image from among a plurality of compression images stored in a memory;
a decoding unit to implement prediction decoding to generate a reconstruction image of the current image by decoding a bitstream and applying the reconstructed reference image to the decoded bitstream; and
a compression unit to reduce a resolution of the generated reconstruction image to compress the reconstruction image and to add the compressed reconstruction image to the plurality of compression images in the memory.

13. A method of decoding a moving image, the method comprising:
reconstructing a reference image of a current image by increasing a resolution of a compression image corresponding to the reference image from among a plurality of compression images stored in a memory;
generating a prediction image of the current image from the reconstructed reference image;
reconstructing a residue image between the generated prediction image and the current image through a decoding of a bitstream;
reducing a resolution of the reconstructed residue image;
generating a reconstruction image of the current image by adding the reduced resolution residue image to the generated prediction image; and
reducing a resolution of the generated reconstruction image to compress the reconstruction image and adding the compressed reconstruction image to the plurality of compression images in the memory.

14. A method of decoding a moving image, the method comprising:
reconstructing a reference image of a current image by increasing a resolution of a compression image corresponding to the reference image from among a plurality of compression images stored in a memory;
generating a prediction image of the current image from the reconstructed reference image;
reconstructing a residue image between the generated prediction image and the current image through a decoding of a bitstream;
generating a reconstruction image of the current image by adding the reconstructed residue image to the generated prediction image; and
reducing a resolution of the generated reconstruction image to compress the reconstruction image and adding the compressed reconstruction image to the plurality of compression images in the memory.

15. A method of compressing an image, the method comprising:
selecting an offset value of a predetermined-size block of an image, from among a plurality of offset values, based on values of pixels making up the block;
selecting a quantization size of the block, from among a plurality of quantization sizes, based on the values of the pixels of the block; and
performing a quantization operation by dividing differences between respective values of the pixels and the selected offset value by the selected quantization size.

16. The method of claim 15, wherein the selection of the offset value comprises selecting an offset value that is closest to, but less than, a minimum value among the values of the pixels of the block, and
the selection of the quantization size comprises selecting a quantization size closest to a minimum number of bits that are sufficient to indicate a difference between the selected offset value and a maximum value among the values of the pixels of the block.

17. The method of claim 15, wherein color values corresponding to a chrominance component from among the values of the pixels of the block are expressed with absolute values of values obtained by subtracting 128 from the color values and with corresponding signs, and
the performing of the quantization operation comprises dividing differences between respective absolute values and the selected offset value by the selected quantization size.

18. The method of claim 15, further comprising extracting bits corresponding to a predetermined bit size from among bits indicating a quantization value of each of the pixels and combining extracted fixed-length bits of each of the pixels, fixed-length bits indicating the selected offset value, and fixed-length bits indicating the selected quantization size in order to generate a fixed-length block.

19. A method of reconstructing an image, the method comprising:
extracting an offset value of a predetermined-size block of an image and a quantization size of the block from the block; and
performing an inverse quantization operation by multiplying a quantization value of each of plural pixels making up the block by the extracted quantization size and summing a result of the multiplication and the extracted offset value to reconstruct original bits of each of the plural pixels.

20. The method of claim 19, wherein color values corresponding to a chrominance component from among the values of the plural pixels of the block are expressed with absolute values of values obtained by subtracting 128 from the color values and with corresponding signs, and
the performing of the inverse quantization operation comprises multiplying quantization values corresponding to the chrominance component, from among the quantization values of the plural pixels, by the extracted quantization size and summing a result of the multiplication of the quantization values corresponding to the chrominance component and the extracted offset value to reconstruct the absolute values.

21. The method of claim 19, further comprising extracting fixed-length coding values of the plural pixels from the block and performing fixed-length decoding on the extracted fixed-length coding values to reconstruct the quantization values of the plural pixels.
